(19) United States
(12) Patent Application Publication
(10) Pub. No.: US 2024/0165485 A1
(43) Pub. Date: May 23, 2024

(54) SPORTS ARTICLE DISPLAY DEVICE

(71) Applicant: Allan Robert Bell, JR., Suwanee, GA (US)

(72) Inventor: Allan Robert Bell, JR., Suwanee, GA (US)

(21) Appl. No.: 17/993,677

(22) Filed: Nov. 23, 2022

(51) Int. Cl. A63B 71/06; A63B 43/00

(52) U.S. Cl. CPC A63B 71/0622; A63B 43/00; A63B 2225/50

(57) ABSTRACT

A sports article display device, including a main body, an inner tube disposed within at least a portion of the main body, an eyepiece removably connected to at least a portion of the inner tube to facilitate viewing, and a filtering lens removably connected to at least a portion of the inner tube to receive a picture thereon to be viewed through the eyepiece.

### BACKGROUND

### 1. Field

The present general inventive concept relates generally to a display device, and particularly, to a sports article display device.

### 2. Description of the Related Art

Sports encompass a wide variety of physical activities and/or games, which require a high level of physical ability and/or skill. Moreover, sports can be played either individually and/or on a team. In many cases, a contest can be used to organize a series of competitions to determine a winner.

In some types of sports, the contests between the individual and/or the is arranged by a professional league. The contests may occur during a regular sports season that includes a fixed number of games until a playoff is held. Conclusion of the playoff is used to determine a champion during the regular sports season.

Fans of sports will frequently search for images of players, videos of games, sports statistics, photographs, and/or non-fungible tokens (NFT) on a computing device, such as a mobile device, a cell phone, a laptop computer, and a desktop computer. However, using the computing device takes time and is inefficient because a user will have to load up different programs and enable access to the computing device, such as a browser, an image viewer, and/or any other programs necessary to perform operations desired by the user.

Furthermore, the computing device lacks any support for sports. Specifically, the user cannot use the computing device to play a game and/or have appearance of a sports article (e.g., a ball, a helmet). In other words, the computing device lacks any utility that could be used for physical activity without causing damage to the computing device.

Therefore, there is a need for a sports article display device that can be used similar to any other sports article, but also allows sports related images, videos, photographs, and/or NFTs to be viewed during use.

### SUMMARY

The present general inventive concept provides a sports article display device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a sports article display device, including a main body, an inner tube disposed within at least a portion of the main body, an eyepiece removably connected to at least a portion of the inner tube to facilitate viewing, and a filtering lens removably connected to at least a portion of the inner tube to receive a picture thereon to be viewed through the eyepiece.

The sports article display device may further include a viewer body removably disposed within at least a portion of the inner tube, the viewer body including a first section, and a second section removably connected to at least a portion of the first section, such that the first section and second section receive the filtering lens therebetween.

The first section and the second section each may include a magnifier receiving groove disposed on at least a portion of the first section and the second section, and a lens receiving groove disposed on at least a portion of the first section and the second section to receive the filtering lens therein, such that the lens receiving groove protrudes away from an outer surface of the first section and an outer surface of the second section, and is recessed on an interior of the first section and the second section.

The sports article display device may further include a magnification lens removably connected to at least a portion of the viewer body to magnify the picture on the filtering lens while viewing the picture through the eyepiece.

The filtering lens may receive light from an external environment to illuminate the picture.

The foregoing and/or other features and utilities of the present general inventive concept may also be achieved by providing a sports article display device, including a main body, an inner tube disposed within at least a portion of the main body, a display unit disposed at an end of the inner tube to display at least one image thereon, and a control unit disposed within at least a portion of the inner tube and connected to the display unit to receive the at least one image to be displayed on the display unit.

The control unit may receive the at least one image from an external device connected to the control unit.

The control unit may adjust at least one setting in response to receiving an input signal from an external device.

The control unit may automatically retrieve the at least one image from an external device to be displayed on the display unit in response to the external device being within a predetermined distance of the control unit.

The sports article display device may further include an eyepiece removably connected to at least a portion of the inner tube to facilitate viewing of the display unit.

The foregoing and/or other features and utilities of the present general inventive concept may also be achieved by providing a sports article display device, including a main body, an inner tube disposed within at least a portion of the main body, an image projecting unit disposed within at least a portion of the main body to display at least one image away therefrom to another medium outside a boundary of the main body, and a control unit disposed within at least a portion of the inner tube and connected to the image projecting unit to receive the at least one image to be to be displayed by the image projecting unit.

The image projecting unit may project the at least one image on the another medium.

The image projecting unit may broadcast, via a signal, the at least one image onto an external display screen.

The image projecting unit may project a holographic display of the at least one image, such that the holographic display is three-dimensional.

The control unit may extract at least one of image data and video data stored thereon to overlay the at least one image.

The foregoing and/or other features and utilities of the present general inventive concept may also be achieved by providing a sports article display device, including a main body, an inner tube disposed within at least a portion of the main body, an eyepiece removably connected to at least a portion of the inner tube to facilitate viewing, a filtering lens removably connected to at least a portion of the inner tube to receive a picture thereon for viewing through the eyepiece, and an inflatable bladder disposed within at least a portion of the main body to contact at least a portion of an interior surface of the main body and prevent compression of the main body from an application of force.

The inflatable bladder may increase a rigidity level of the main body.

The inflatable bladder may have a ring shape.

The sports article display device may further include an inflation aperture disposed on at least a portion of the main body to receive an air supply unit therein.

The inflation aperture may connect only to the inflatable bladder.

The foregoing and/or other features and utilities of the present general inventive concept may also be achieved by providing a sports article display device, including a main body, an inner tube disposed within at least a portion of the main body, an eyepiece removably connected to at least a portion of the inner tube to facilitate viewing, a display unit disposed within at least a portion of the inner tube to perform at least one of receiving at least one picture thereon for viewing through the eyepiece, displaying at least one image thereon, and displaying the at least one image away therefrom to another medium outside a boundary of the main body, a control unit disposed within at least a portion of the inner tube and connected to the display unit to receive the at least image to be displayed on the display unit, and an inflatable bladder disposed within at least a portion of the main body to contact at least a portion of an interior surface of the main body and prevent compression of the main body from an application of force.

The eyepiece may be prevented from viewing the at least one image while the at least one picture remains on the display unit.

The control unit may prevent the display unit from displaying the at least one image in response to the display unit detecting a presence of the at least one picture.

The control unit may extract at least one of image data and video data stored thereon to overlay the at least one image.

The sports article display device may further include an inflation aperture disposed on at least a portion of the main body to receive an air supply unit therein.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1A illustrates a sectional view of a sports article display device, according to an exemplary embodiment of the present general inventive concept;

FIG. 1B illustrates a sectional view of the sports article display device, according to an exemplary embodiment of the present general inventive concept;

FIG. 1C illustrates a sectional view of the sports article display device, according to an exemplary embodiment of the present general inventive concept;

FIG. 1D illustrates a sectional view of the sports article display device, according to an exemplary embodiment of the present general inventive concept;

FIG. 2 illustrates a sectional view of a sports article display device, according to another exemplary embodiment of the present general inventive concept;

FIG. 3 illustrates a sectional view of a sports article display device, according to another exemplary embodiment of the present general inventive concept;

FIG. 4 illustrates a sectional view of a sports article display device, according to another exemplary embodiment of the present general inventive concept;

FIG. 5 illustrates a sectional view of a sports article display device, according to another exemplary embodiment of the present general inventive concept;

FIG. 6 illustrates a sectional view of a sports article display device, according to another exemplary embodiment of the present general inventive concept;

FIG. 7 illustrates a sectional view of a sports article display device, according to another exemplary embodiment of the present general inventive concept;

FIG. 8 illustrates a sectional view of a sports article display device, according to another exemplary embodiment of the present general inventive concept;

FIG. 9 illustrates a sectional view of a sports article display device, according to another exemplary embodiment of the present general inventive concept;

FIG. 10A illustrates a perspective view of a sports article display device, according to another exemplary embodiment of the present general inventive concept;

FIG. 10B illustrates a perspective view of a sports article display device, according to another exemplary embodiment of the present general inventive concept;

FIG. 10C illustrates a perspective view of a sports article display device, according to another exemplary embodiment of the present general inventive concept;

FIG. 10D illustrates a perspective view of a sports article display device, according to another exemplary embodiment of the present general inventive concept;

FIG. 10E illustrates a perspective view of a sports article display device, according to another exemplary embodiment of the present general inventive concept;

FIG. 10F illustrates a perspective view of a sports article display device, according to another exemplary embodiment of the present general inventive concept;

FIG. 10G illustrates a perspective view of a sports article display device, according to another exemplary embodiment of the present general inventive concept;

FIG. 10H illustrates a perspective view of a sports article display device, according to another exemplary embodiment of the present general inventive concept; and

FIG. 10I illustrates a perspective view of a sports article display device, according to another exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Sports Article Display Device 100
Main Body 110
Inner Tube 120
Viewer Body 130
First Section 131
First Magnifier Receiving Groove 131a
First Lens Receiving Groove 131b
Second Section 132
Second Magnifier Receiving Groove 132a
Second Lens Receiving Groove 132b
Eyepiece 140
Filtering Lens 150
Magnification Lens 160
Sports Article Display Device 200
Main Body 210
Inner Tube 220
Eyepiece 230
Filtering Lens 240
Sports Article Display Device 300
Main Body 310
Inner Tube 320
Eyepiece 330
Display Unit 340
Control Unit 350
Processing Unit 351
Communication Unit 352
Storage Unit 353
Connection Port 360
Power Source 370
Control Panel 380
Sports Article Display Device 400
Main Body 410
Inner Tube 420
Eyepiece 430
Image Projecting Unit 440
Control Unit 450
Processing Unit 451
Communication Unit 452
Storage Unit 453
Connection Port 460
Power Source 470
Control Panel 480
Sports Article Display Device 500
Main Body 510
Inner Tube 520
Viewer Body 530
First Section 531
First Magnifier Receiving Groove 531a
First Lens Receiving Groove 531b
Second Section 532
Second Magnifier Receiving Groove 532a
Second Lens Receiving Groove 532b
Eyepiece 540
Filtering Lens 550
Magnification Lens 560
Inflatable Bladder 570
Inflation Aperture 580
Sports Article Display Device 600
Main Body 610
Inner Tube 620
Viewer Body 630
First Section 631
First Magnifier Receiving Groove 631a
First Lens Receiving Groove 631b
Second Section 632
Second Magnifier Receiving Groove 632a
Second Lens Receiving Groove 632b
Eyepiece 640
Display Unit 650
Inflatable Bladder 655
Inflation Aperture 656
Magnification Lens 660
Control Unit 670
Processing Unit 671
Communication Unit 672
Storage Unit 673
Connection Port 680
Control Panel 685
Power Source 690
Sports Article Display Device 700
Main Body 710
Inner Tube 720
Viewer Body 730
First Section 731
First Magnifier Receiving Groove 731a
First Lens Receiving Groove 731b
Second Section 732
Second Magnifier Receiving Groove 732a
Second Lens Receiving Groove 732b
Eyepiece 740
Filtering Lens 750
Magnification Lens 760
Sports Article Display Device 800
Main Body 810
Inner Tube 820
Viewer Body 830
First Section 831
First Magnifier Receiving Groove 831a
First Lens Receiving Groove 831b
Second Section 832
Second Magnifier Receiving Groove 832a
Second Lens Receiving Groove 832b
Eyepiece 840
Filtering Lens 850
Magnification Lens 860
Sports Article Display Device 900
Main Body 910
Inner Tube 920
Viewer Body 930
First Section 931
First Magnifier Receiving Groove 931a
First Lens Receiving Groove 931b
Second Section 932
Second Magnifier Receiving Groove 932a
Second Lens Receiving Groove 932b
Eyepiece 940
Filtering Lens 950
Magnification Lens 960
Sports Article Display Device 1000
Main Body 1010
Eyepiece 1040
Filtering Lens 1050
Sports Article Display Device 1000
Main Body 1010
Eyepiece 1040
Filtering Lens 1050
Sports Article Display Device 1100
Main Body 1110
Eyepiece 1140
Filtering Lens 1150
Sports Article Display Device 1200
Main Body 1210
Eyepiece 1240
Filtering Lens 1250
Sports Article Display Device 1300
Main Body 1310
Eyepiece 1340
Filtering Lens 1350
Sports Article Display Device 1400
Main Body 1410
Eyepiece 1440
Filtering Lens 1450
Sports Article Display Device 1500
Main Body 1510
Eyepiece 1540
Filtering Lens 1550
Sports Article Display Device 1600
Main Body 1610
Eyepiece 1640
Filtering Lens 1650
Sports Article Display Device 1700
Main Body 1710
Eyepiece 1740
Filtering Lens 1750
Sports Article Display Device 1800
Main Body 1810
Eyepiece 1840
Filtering Lens 1850

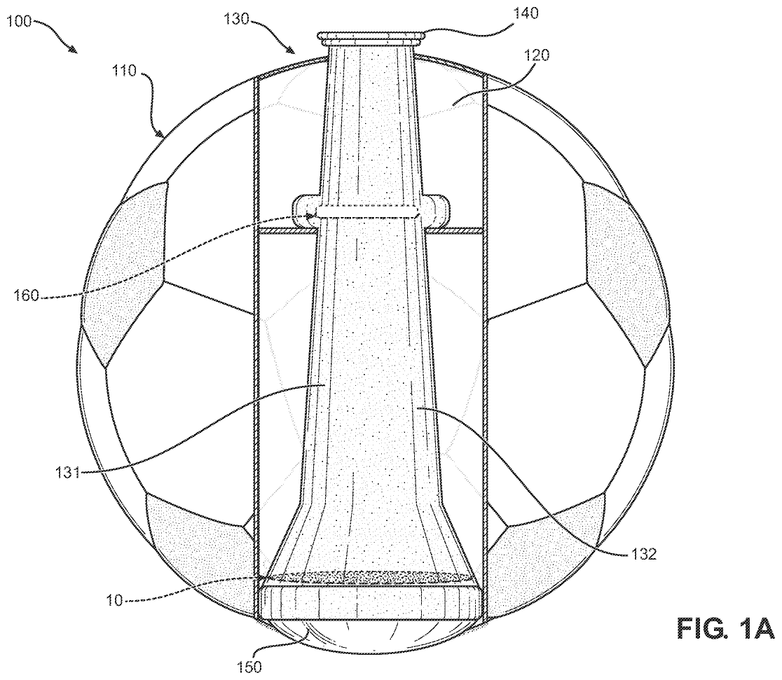

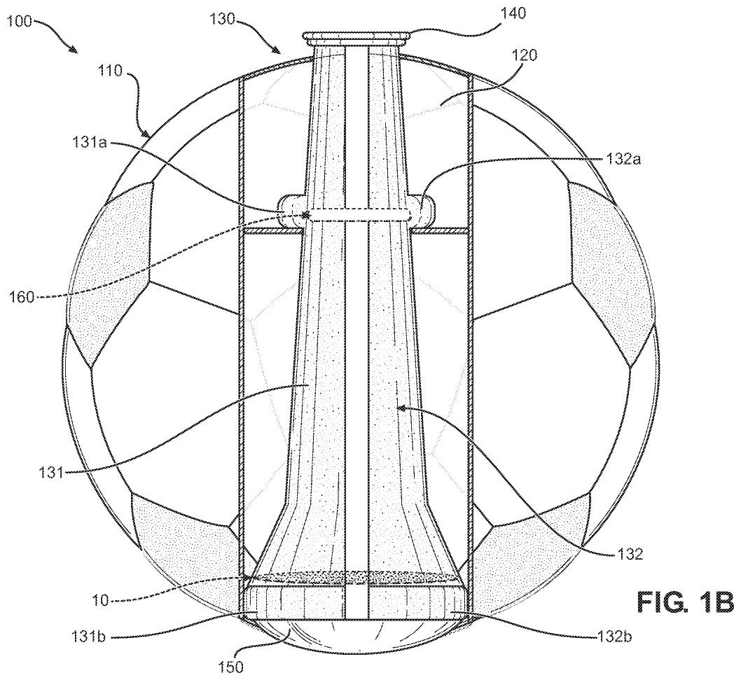

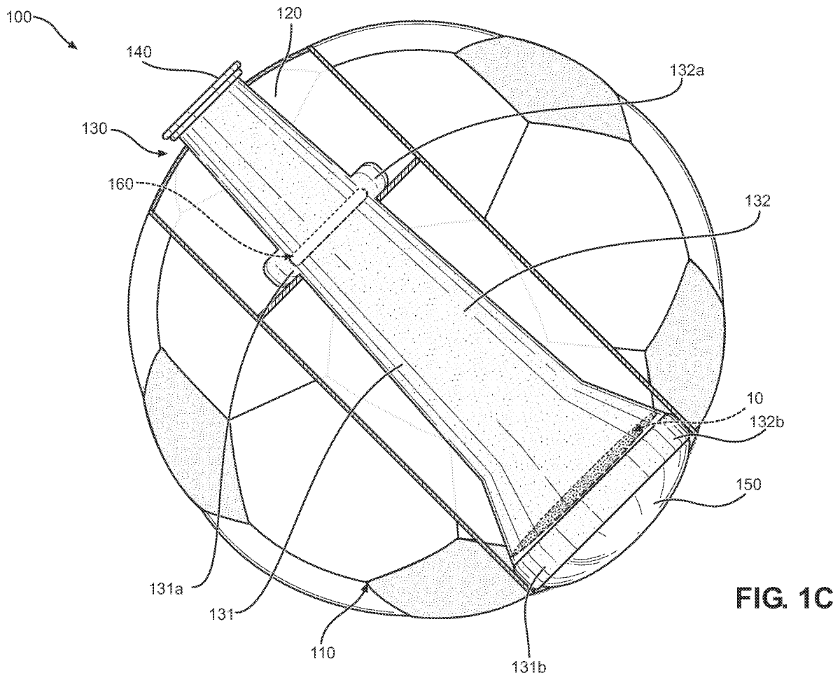

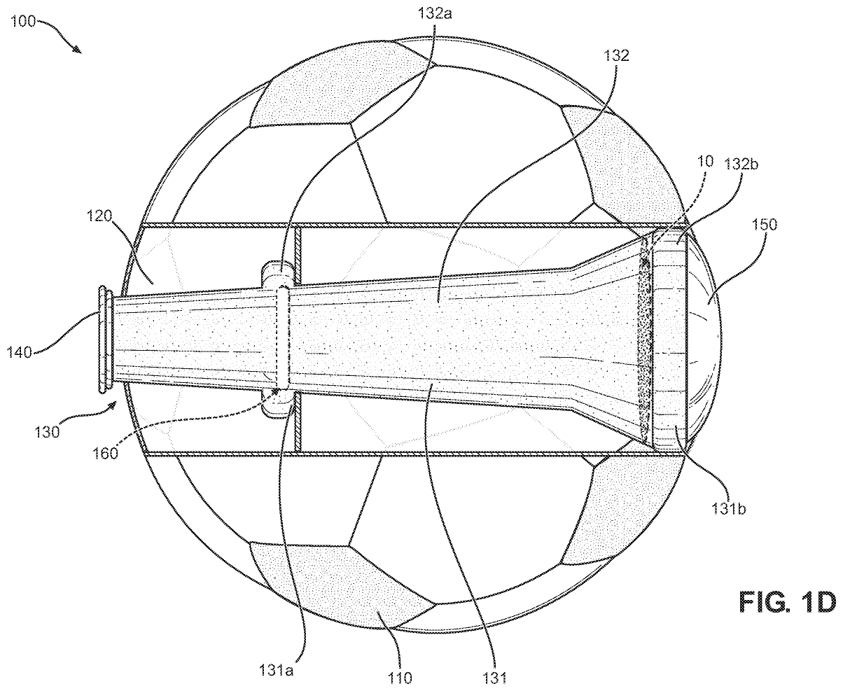

FIG. 1A illustrates a sectional view of a sports article display device 100, according to an exemplary embodiment of the present general inventive concept.

FIG. 1B illustrates a sectional view of the sports article display device 100, according to an exemplary embodiment of the present general inventive concept.

FIG. 1C illustrates a sectional view of the sports article display device 100, according to an exemplary embodiment of the present general inventive concept.

FIG. 1D illustrates a sectional view of the sports article display device 100, according to an exemplary embodiment of the present general inventive concept.

The sports article display device 100 may be constructed from at least one of metal, plastic, wood, glass, and rubber, etc., but is not limited thereto.

The sports article display device 100 may include a main body 110, an inner tube 120, a viewer body 130, an eyepiece 140, a filtering lens 150, and a magnification lens 160, but is not limited thereto.

Referring to FIGS. 1A through 1D, the main body 110 is illustrated to be a soccer ball. However, the main body 110 may be any type of ball, or any other type of sports article known to one of ordinary skill in the art, but is not limited thereto.

The main body 110 may be elastic and/or spherical in shape. More specifically, the main body 110 may at least partially deform in response to an application of force (e.g., pushing, striking) thereto.

The inner tube 120 may be elongate and/or have a cylindrical shape. However, the inner tube 120 may be rectangular, circular, triangular, pentagonal, hexagonal, heptagonal, octagonal, or any other shape known to one of ordinary skill in the art, but is not limited thereto. Additionally, the inner tube 120 may extend at least a portion of a size (e.g., a diameter, a length) of the main body 110.

The inner tube 120 may be disposed within at least a portion of an interior of the main body 110. Moreover, the inner tube 120 may be obscured (i.e., not visible) from an outer surface of the main body 110 and/or an external environment surrounding the main body 110.

The viewer body 130 may be removably disposed (i.e., inserted, attached) within at least a portion of the inner tube 120.

The viewer body 130 may include a first section 131 and a second section 132, but is not limited thereto.

The first section 131 and/or the second section 132 may be removably connected (i.e., clip, clamp, clasp, snap, adhesive (e.g., tape, glue), and/or magnet) to each other. The second section 132 may have a size (e.g., a length, a width, a height) equivalent to a size (e.g., a length, a width, a height) of the first section 131.

The first section 131 may include a first magnifier receiving groove 131a and a first lens receiving groove 131b, but is not limited thereto.

The first magnifier receiving groove 131a may be disposed on at least a portion of the first section 131. The first magnifier receiving groove 131a may protrude away from an outer surface of the first section 131 and be recessed on an interior of the first section 131 corresponding to the protrusion of the first magnifier receiving groove 131a on the outer surface of the first section 131.

The first lens receiving groove 131b may be disposed on at least a portion of a first end of the first section 131. The first lens receiving groove 131b may protrude away from the outer surface of the first section 131 and be recessed on the interior of the first section 131 corresponding to the protrusion of the first lens receiving groove 131b on the outer surface of the first section 131. Also, the first lens receiving groove 131b may be disposed at a distance away from the first magnifier receiving groove 131a.

The second section 132 may include a second magnifier receiving groove 132a and a second lens receiving groove 132b, but is not limited thereto.

The second magnifier receiving groove 132a may be disposed on at least a portion of the second section 132. The second magnifier receiving groove 132a may protrude away from an outer surface of the second section 132 and be recessed on an interior of the second section 132 corresponding to the protrusion of the second magnifier receiving groove 132a on the outer surface of the second section 132.

The second lens receiving groove 132b may be disposed on at least a portion of a first end of the second section 132. The second lens receiving groove 132b may protrude away from the outer surface of the second section 132 and be recessed on the interior of the second section 132 corresponding to the protrusion of the second lens receiving groove 132b on the outer surface of the second section 132. Also, the second lens receiving groove 132b may be disposed at a distance away from the second magnifier receiving groove 132a.

The eyepiece 140 may be removably connected (i.e., clip, clamp, clasp, snap, adhesive (e.g., tape, glue), and/or magnet) to at least a portion of the inner tube 120 and/or a second end of the first section 131 and/or a second end of the second section 132. The eyepiece 140 may include a viewing lens to view contents within the first section 131 and/or the second section 132 by a user. In other words, the eyepiece 140 may facilitate viewing within the first section 131 and/or the second section 132.

The filtering lens 150 may include a transparent optical lens, but is not limited thereto.

The filtering lens 150 may be removably connected (i.e., clip, clamp, clasp, snap, adhesive (e.g., tape, glue), and/or magnet) within the inner tube 120 to at least a portion of the second end of the first section 131 and/or the second end of the second section 132. More specifically, the filtering lens 150 may be removably connected within the first lens receiving groove 131b and/or the second lens receiving groove 132b. In other words, the first section 131 and/or the second section 132 may receive the filtering lens 150 therebetween.

Additionally, the filtering lens 150 may receive a picture 10 thereon, such as a physical photograph, a physical picture, a physical painting, a physical illustration, and/or a physical drawing. During use, the filtering lens 150 may receive light (e.g., sunlight, light source) from the external environment to illuminate the picture 10. Accordingly, the eyepiece 140 may be used to view the picture 10 disposed on the filtering lens 150. As such, the user may view the picture 10 that may be a photograph of a sports player, an athlete, a score sheet from a sports team, a baseball bat, a tennis racket, a football field, and/or any other type of sports related information as desired based on a preference of the user.

The magnification lens 160 may be removably connected (i.e., clip, clamp, clasp, snap, adhesive (e.g., tape, glue), and/or magnet) to at least a portion of the first section 131 and/or the second section 132. More specifically, the magnification lens 160 may be removably connected within the first magnifier receiving groove 131a and/or the second magnifier receiving groove 132a. In other words, the first section 131 and/or the second section 132 may receive the magnification lens 160 therebetween.

The magnification lens 160 may refract light moving therethrough. Moreover, the magnification lens 160 may magnify the picture 10 on the filtering lens 150 while being viewed through the eyepiece 140. As such, the magnification lens 160 may enhance and/or improve viewing of the picture 10 by the user.

Therefore, the sports article display device 100 may allow viewing of the picture 10 while allowing enjoyment of the main body 110 that represents sports memorabilia. Also, the sports article display device 100 may be used for a purpose related to sports.

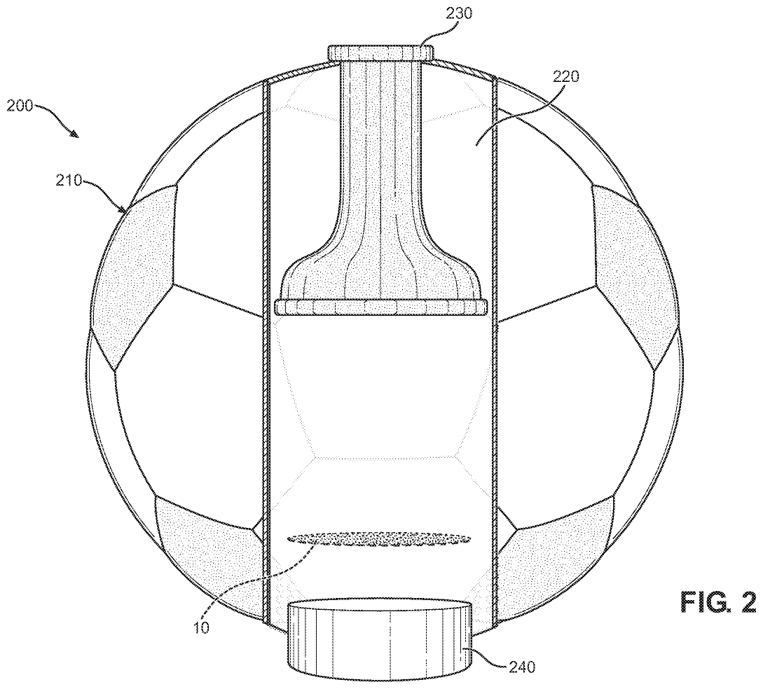

FIG. 2 illustrates a sectional view of a sports article display device 200, according to another exemplary embodiment of the present general inventive concept.

The sports article display device 200 may be constructed from at least one of metal, plastic, wood, glass, and rubber, etc., but is not limited thereto.

The sports article display device 200 may include a main body 210, an inner tube 220, an eyepiece 230, and a filtering lens 240, but is not limited thereto.

Referring to FIG. 2, the main body 210 is illustrated to be a soccer ball. However, the main body 210 may be any type of ball, or any other type of sports article known to one of ordinary skill in the art, but is not limited thereto.

The main body 210 may be elastic. More specifically, the main body 210 may at least partially deform in response to an application of force (e.g., pushing, striking) thereto.

The inner tube 220 may be elongate and/or have a cylindrical shape. However, the inner tube 220 may be rectangular, circular, triangular, pentagonal, hexagonal, heptagonal, octagonal, or any other shape known to one of ordinary skill in the art, but is not limited thereto. Additionally, the inner tube 220 may extend at least a portion of a size (e.g., a diameter, a length) of the main body 210.

The inner tube 220 may be disposed within at least a portion of an interior of the main body 210. Moreover, the inner tube 220 may be obscured (i.e., not visible) from an outer surface of the main body 210 and/or an external environment surrounding the main body 210.

The eyepiece 230 may be removably connected (i.e., clip, clamp, clasp, snap, adhesive (e.g., tape, glue), and/or magnet) to at least a portion of a first end of the inner tube 220. The eyepiece 230 may include a viewing lens to view contents within the inner tube 220 by a user. In other words, the eyepiece 230 may facilitate viewing within the inner tube 220.

The filtering lens 240 may include a transparent optical lens, but is not limited thereto.

The filtering lens 240 may be removably connected (i.e., clip, clamp, clasp, snap, adhesive (e.g., tape, glue), and/or magnet) to at least a portion of a second end of the inner tube 220. More specifically, the filtering lens 240 may be removably connected within the inner tube 220.

Additionally, the filtering lens 240 may receive a picture 10 thereon, such as a physical photograph, a physical picture, a physical painting, a physical illustration, and/or a physical drawing. During use, the filtering lens 240 may receive light (e.g., sunlight, light source) from the external environment to illuminate the picture 10. Accordingly, the eyepiece 230 may be used to view the picture 10 disposed on the filtering lens 240. As such, the user may view the picture 10 that may be a photograph of a sports player, an athlete, a score sheet from a sports team, a baseball bat, a tennis racket, a football field, and/or any other type of sports related information as desired based on a preference of the user.

Therefore, the sports article display device 200 may allow viewing of the picture 10 while allowing enjoyment of the main body 210 that represents sports memorabilia. Also, the sports article display device 200 may be used for a purpose related to sports.

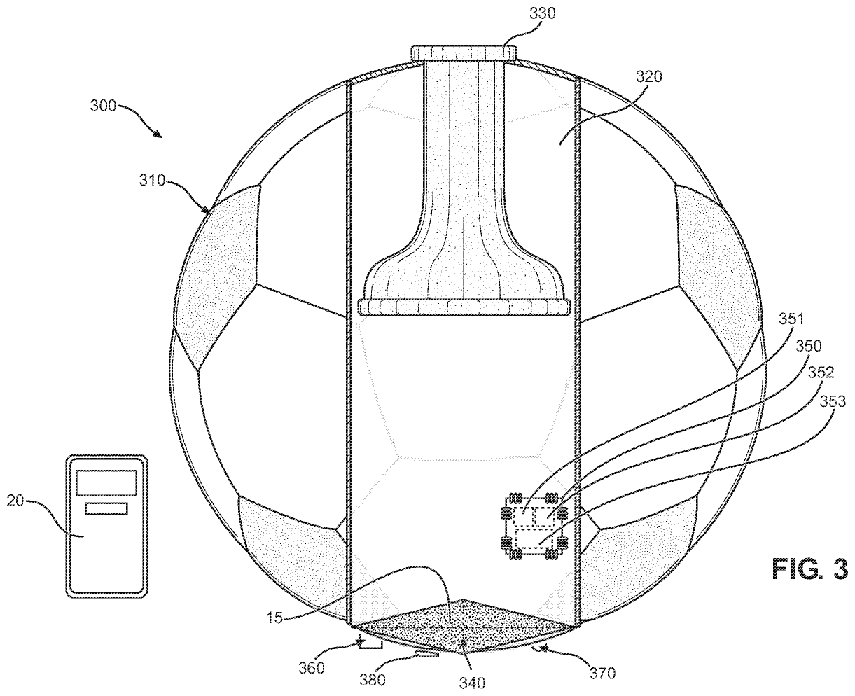

FIG. 3 illustrates a sectional view of a sports article display device 300, according to another exemplary embodiment of the present general inventive concept.

The sports article display device 300 may be constructed from at least one of metal, plastic, wood, glass, and rubber, etc., but is not limited thereto.

The sports article display device 300 may include a main body 310, an inner tube 320, an eyepiece 330, a display unit 340, a control unit 350, a connection port 360, a power source 370, and a control panel 380, but is not limited thereto.

Referring to FIG. 3, the main body 310 is illustrated to be a soccer ball. However, the main body 310 may be any type of ball, or any other type of sports article known to one of ordinary skill in the art, but is not limited thereto.

The main body 310 may be elastic. More specifically, the main body 310 may at least partially deform in response to an application of force (e.g., pushing, striking) thereto.

The inner tube 320 may be elongate and/or have a cylindrical shape. However, the inner tube 320 may be rectangular, circular, triangular, pentagonal, hexagonal, heptagonal, octagonal, or any other shape known to one of ordinary skill in the art, but is not limited thereto. Additionally, the inner tube 320 may extend at least a portion of a size (e.g., a diameter, a length) of the main body 310.

The inner tube 320 may be disposed within at least a portion of an interior of the main body 310. Moreover, the inner tube 320 may be obscured (i.e., not visible) from an outer surface of the main body 310 and/or an external environment surrounding the main body 310.

The eyepiece 330 may be removably connected (i.e., clip, clamp, clasp, snap, adhesive (e.g., tape, glue), and/or magnet) to at least a portion of a first end of the inner tube 320. The eyepiece 330 may include a viewing lens to view contents within the inner tube 320 by a user. In other words, the eyepiece 330 may facilitate viewing within the inner tube 320.

The display unit 340 may include a plasma screen, an LCD screen, a light emitting diode (LED) screen, an organic LED (OLED) screen, a computer monitor, a hologram output unit, a sound outputting unit, or any other type of device that visually or aurally displays data.

The display unit 340 may be disposed within at least a portion of a second end of the inner tube 320 and/or within at least a portion of the main body 310. The display unit 340 may display an image 15 thereon, such as a sheet of sports statistics, a digital photograph, a digital painting, a video, a video of a player, a video of a sports game, a non-fungible token (NFT), and/or a digital image. In other words, the display unit 340 may use a screen to display the image 15. It is important to note that this substantially differs from the picture 10 used for the sports article display device 100 and/or the sports article display device 200.

Accordingly, the eyepiece 330 may be used to view the image 15 displayed on the display unit 340. As such, the user may view the image 15 that may be a photograph of a sports player, an athlete, a score sheet from a sports team, a baseball bat, a tennis racket, a football field, and/or any other type of sports related information as desired based on a preference of the user

The control unit 350 may be disposed within at least a portion of the inner tube 320 and/or connected to the display unit 340.

The control unit 350 may include a processing unit 351, a communication unit 352, and a storage unit 353, but is not limited thereto.

The processing unit 351 (or central processing unit, CPU) may include electronic circuitry to carry out instructions of a computer program by performing basic arithmetic, logical, control and input/output (I/O) operations specified by the instructions. The processing unit 351 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 351 may also include a microprocessor and a microcontroller.

The communication unit 352 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet.

The storage unit 353 may include a random access memory (RAM), a read-only memory (ROM), a hard disk, a flash drive, a database connected to the Internet, cloud-based storage, Internet-based storage, or any other type of storage unit.

The control unit 350 may access the Internet via the communication unit 352 to allow the user to access a website, and/or may allow a software application to be executed using the processing unit 351. For ease of description, the software application will be hereinafter referred to as an app. The app may be downloaded from the Internet to be stored on the storage unit 353.

The processing unit 351 executing the app may receive and/or retrieve the image 15 from the storage unit 353 to be displayed by the display unit 340. Moreover, the processing unit 351 executing the app may send a variety of and/or a plurality of images 15 to the display unit 340 based on the preference of the user. Accordingly, the display unit 340 may cycle through the plurality of images 15 at a predetermined interval based on instructions received by the processing unit 351 executing the app. The processing unit 351 executing the app may extract image data and/or video data stored on the storage unit 353 to overlay the image data and/or the video data on the image 15 (e.g., a picture of the user with a sports player).

The communication unit 352 may receive an input signal from an external device 20 (e.g., a mobile device, a cell phone, a laptop computer, a desktop computer, a tablet computer, a personal digital assistant (PDA), a smart watch, a cloud computer, a cloud storage device, a network computer) to adjust at least one setting of the processing unit 351 via the app. For example, the processing unit 351 may receive the input signal from the external device 20 to display a single image 15 and/or the plurality of images 15.

Furthermore, the communication unit 352 may receive a signal from the external device 20 to be processed by the processing unit 351 to display the image 15 on the display unit 340. In other words, the display unit 340 may display the image 15 in response to the communication unit 352 receiving the signal from the external device 20. Also, the processing unit 351 may automatically retrieve the image 15 from the external device 20 to be displayed by the display unit 340 in response to the external device 20 moving within a predetermined distance (e.g., one foot, two feet, five feet, ten feet, twenty feet) from the communication unit 352 (e.g., via NFC).

The storage unit 353 may store the image 15, the plurality of images 15, the at least one setting of the processing unit 351, and/or the app thereon. As such, the processing unit 351 may execute instructions of the app and/or retrieve data stored on the storage unit 353.

The connection port 360 may include a universal serial bus (USB) port, a serial port, a parallel port, a FireWire port, and an Ethernet port, but is not limited thereto.

The connection port 360 may be disposed on and/or within at least a portion of the main body 310. The connection port 360 may receive and/or connect to an external cord therein. For example, the connection port 360 may connect to the external device 20 using the external cord. Alternatively, the connection port 360 may be used to charge the power source 370.

Furthermore, the connection port 360 may be used to receive and/or connect to a flash drive and/or a cloud device. In other words, the processing unit 351 executing the app may extract the image 15 from the flash drive, the cloud device, and/or the external device 20 to be displayed by the display unit 340.

The power source 370 may include a power inlet, a battery, and a solar cell, but is not limited thereto.

The power source 370 may be disposed on and/or within at least a portion of the main body 310. The power source 370 may provide power to the display unit 340, the control unit 350, and/or the connection port 360. The power source 370 may charge the battery in response to receiving power from an external power source (e.g., a power outlet) through the connection port 360 and/or receiving light from an external light source via the solar cell.

The control panel 380 may include a power button (e.g., on/off button), a menu button, a plurality of scrolling buttons (e.g., an up button, a down button), and an enter button, but is not limited thereto.

The control panel 380 may be disposed on at least a portion of the main body 310. The control panel 380 may turn on the display unit 340, the control unit 350, the connection port 360, and/or the power source 370 in response to depressing the power button a first time. Conversely, the control panel 380 may turn off the display unit 340, the control unit 350, the connection port 360, and/or the power source 370 in response to depressing the power button a second time. Additionally, the control panel 380 may activate a menu on the display unit 340, such that at least one of the plurality of images 15 may be selected. Moreover, the plurality of scrolling buttons of the control panel 380 may be used to select options of the menu on the display unit 340. Lastly, the enter button of the control panel 380 may be used to enter (i.e., confirm) entry of a selection, such as the image 15 to be displayed on the display unit 340.

The external device 20 may perform all function of the control panel 380.

Therefore, the sports article display device 300 may allow viewing of the image 15 while allowing enjoyment of the main body 310 that represents sports memorabilia. Also, the sports article display device 300 may be used for a purpose related to sports.

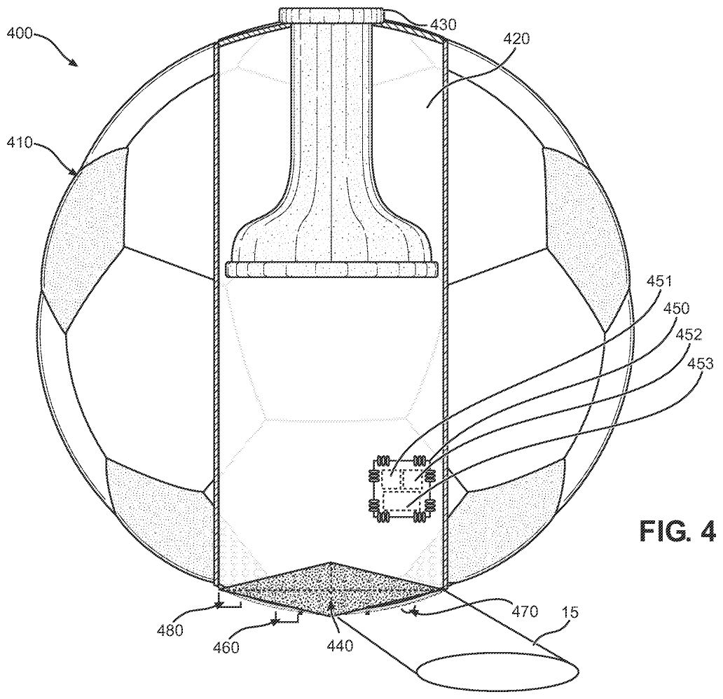

FIG. 4 illustrates a sectional view of a sports article display device 400, according to another exemplary embodiment of the present general inventive concept.

The sports article display device 400 may be constructed from at least one of metal, plastic, wood, glass, and rubber, etc., but is not limited thereto.

The sports article display device 400 may include a main body 410, an inner tube 420, an eyepiece 430, an image projecting unit 440, a control unit 450, a connection port 460, and a power source 470, but is not limited thereto.

Referring to FIG. 4, the main body 410 is illustrated to be a soccer ball. However, the main body 410 may be any type of ball, or any other type of sports article known to one of ordinary skill in the art, but is not limited thereto.

The main body 410 may be elastic. More specifically, the main body 410 may at least partially deform in response to an application of force (e.g., pushing, striking) thereto.

The inner tube 420 may be elongate and/or have a cylindrical shape. However, the inner tube 420 may be rectangular, circular, triangular, pentagonal, hexagonal, heptagonal, octagonal, or any other shape known to one of ordinary skill in the art, but is not limited thereto. Additionally, the inner tube 420 may extend at least a portion of a size (e.g., a diameter, a length) of the main body 410.

The inner tube 420 may be disposed within at least a portion of an interior of the main body 410. Moreover, the inner tube 420 may be obscured (i.e., not visible) from an outer surface of the main body 410 and/or an external environment surrounding the main body 410.

The eyepiece 430 may be removably connected (i.e., clip, clamp, clasp, snap, adhesive (e.g., tape, glue), and/or magnet) to at least a portion of a first end of the inner tube 420. The eyepiece 430 may include a viewing lens to view contents within the inner tube 420 by a user. In other words, the eyepiece 430 may facilitate viewing within the inner tube 420.

The image projecting unit 440 may include a projector, a hologram output unit, a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet, or any other type of device that visually displays data.

The image projecting unit 440 may be disposed within at least a portion of a second end of the inner tube 420 and/or within at least a portion of the main body 410. The image projecting unit 440 may display, cast, and/or broadcast an image 15 thereon, such as a sheet of sports statistics, a digital photograph, a digital painting, a video, a video of a player, a video of a sports game, a non-fungible token (NFT), and/or a digital image. More specifically, the image projecting unit 440 may project the image 15 on the external surface and/or another medium (e.g., a wall, a ground surface, a projector screen, a movie screen, table, etc.) outside a boundary of the main body 410, such that the image 15 is a two-dimensional (2-D) display of the image 15. It is important to note that this substantially differs from the picture 10 used for the sports article display device 200, the sports article display device 200, and/or the sports article display device 300.

Alternatively, the image projecting unit 440 may broadcast, via a signal, the image 15 onto an external display, such as a television (TV), a computer monitor, a mobile device, a cell phone, a smart watch, a tablet computer, a laptop computer, a desktop computer, and/or any other type of external display. As such, the image 15 may be viewed on the external display as transmitted by the image projecting unit 440.

Furthermore, the image projecting unit 440 may project and/or render a holographic display of the image 15 onto the external surface and/or the another medium outside the boundary of the main body 410. Thus, the image projecting unit 440 may create a three-dimensional (3-D) render of the image 15 as a hologram. The image projecting unit 440 displaying the image 15 as the hologram differs from displaying the image 15 as a 2-D image as described above.

The image projecting unit 440 may display the image 15 by saving the image 15 on the external device 20, sharing the image 15 to the external device 20, transmitting the image 15 to the external device 20, and/or uploading the image to the external device 20.

Accordingly, the eyepiece 430 may be used to view the image 15 displayed on the image projecting unit 440. Moreover, the eyepiece 430 may view the image projecting unit 440 prior to being projected away from the image projecting unit 440. As such, the user may view the image 15 that may be a photograph of a sports player, an athlete, a score sheet from a sports team, a baseball bat, a tennis racket, a football field, and/or any other type of sports related information as desired based on a preference of the user.

The control unit 450 may be disposed within at least a portion of the inner tube 420 and/or connected to the image projecting unit 440.

The control unit 450 may include a processing unit 451, a communication unit 452, and a storage unit 453, but is not limited thereto.

The processing unit 451 (or central processing unit, CPU) may include electronic circuitry to carry out instructions of a computer program by performing basic arithmetic, logical, control and input/output (I/O) operations specified by the instructions. The processing unit 451 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 451 may also include a microprocessor and a microcontroller.

The communication unit 452 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet.

The storage unit 453 may include a random access memory (RAM), a read-only memory (ROM), a hard disk, a flash drive, a database connected to the Internet, cloud-based storage, Internet-based storage, or any other type of storage unit.

The control unit 450 may access the Internet via the communication unit 452 to allow the user to access a website, and/or may allow a software application to be executed using the processing unit 451. For ease of description, the software application will be hereinafter referred to as an app. The app may be downloaded from the Internet to be stored on the storage unit 453.

The processing unit 451 executing the app may receive and/or retrieve the image 15 from the storage unit 453 to be displayed by the image projecting unit 440. Moreover, the processing unit 451 executing the app may send a variety of and/or a plurality of images 15 to the image projecting unit 440 based on the preference of the user. Accordingly, the image projecting unit 440 may cycle through the plurality of images 15 at a predetermined interval based on instructions received by the processing unit 451 executing the app. The processing unit 451 executing the app may extract image data and/or video data stored on the storage unit 453 to overlay the image data and/or the video data on the image 15 (e.g., an image of the user with a sports player, a player on a field and/or a court of the sports player in a video).

The communication unit 452 may receive an input signal from an external device 20 (e.g., a mobile device, a cell phone, a laptop computer, a desktop computer, a tablet computer, a personal digital assistant (PDA), a smart watch, a cloud computer, a cloud storage device, a network computer) to adjust at least one setting of the processing unit 451 via the app. For example, the processing unit 451 may receive the input signal from the external device 20 to display a single image 15 and/or the plurality of images 15.

Furthermore, the communication unit 452 may receive a signal from the external device 20 to be processed by the processing unit 451 to display the image 15 by the image projecting unit 440. In other words, the image projecting unit 440 may display the image 15 in response to the communication unit 452 receiving the signal from the external device 20. Also, the processing unit 451 may automatically retrieve the image 15 from the external device 20 to be displayed by the image projecting unit 440 in response to the external device 20 moving within a predetermined distance (e.g., one foot, two feet, five feet, ten feet, twenty feet) from the communication unit 452 (e.g., via NFC).

The storage unit 453 may store the image 15, the plurality of images 15, the at least one setting of the processing unit 451, and/or the app thereon. As such, the processing unit 451 may execute instructions of the app and/or retrieve data stored on the storage unit 453.

The connection port 460 may include a universal serial bus (USB) port, a serial port, a parallel port, a FireWire port, and an Ethernet port, but is not limited thereto.

The connection port 460 may be disposed on and/or within at least a portion of the main body 410. The connection port 460 may receive and/or connect to an external cord therein. For example, the connection port 460 may connect to the external device 20 using the external cord. Alternatively, the connection port 460 may be used to charge the power source 470.

Furthermore, the connection port 460 may be used to receive and/or connect to a flash drive and/or a cloud device. In other words, the processing unit 451 executing the app may extract the image 15 from the flash drive, the cloud device, and/or the external device 20 to be displayed by the image projecting unit 440.

The power source 470 may include a power inlet, a battery, and a solar cell, but is not limited thereto.

The power source 470 may be disposed on and/or within at least a portion of the main body 410. The power source 470 may provide power to the image projecting unit 440, the control unit 450, and/or the connection port 460. The power source 470 may charge the battery in response to receiving power from an external power source (e.g., a power outlet) through the connection port 460 and/or receiving light from an external light source via the solar cell.

The control panel 480 may include a power button (e.g., on/off button), a menu button, a plurality of scrolling buttons (e.g., an up button, a down button), and an enter button, but is not limited thereto.

The control panel 480 may be disposed on at least a portion of the main body 410. The control panel 480 may turn on the image projecting unit 440, the control unit 450, the connection port 460, and/or the power source 470 in response to depressing the power button a first time. Conversely, the control panel 480 may turn off the image projecting unit 440, the control unit 450, the connection port 460, and/or the power source 470 in response to depressing the power button a second time. Additionally, the control panel 380 may activate a menu on the image projecting unit 440, such that at least one of the plurality of images 15 may be selected. Moreover, the plurality of scrolling buttons of the control panel 380 may be used to select options of the menu on the image projecting unit 440. Lastly, the enter button of the control panel 380 may be used to enter (i.e., confirm) entry of a selection, such as the image 15 to be displayed by the image projecting unit 440.

The external device 20 may perform all function of the control panel 480.

Therefore, the sports article display device 400 may allow viewing of the image 15 while allowing enjoyment of the main body 410 that represents sports memorabilia. Also, the sports article display device 400 may be used for a purpose related to sports.

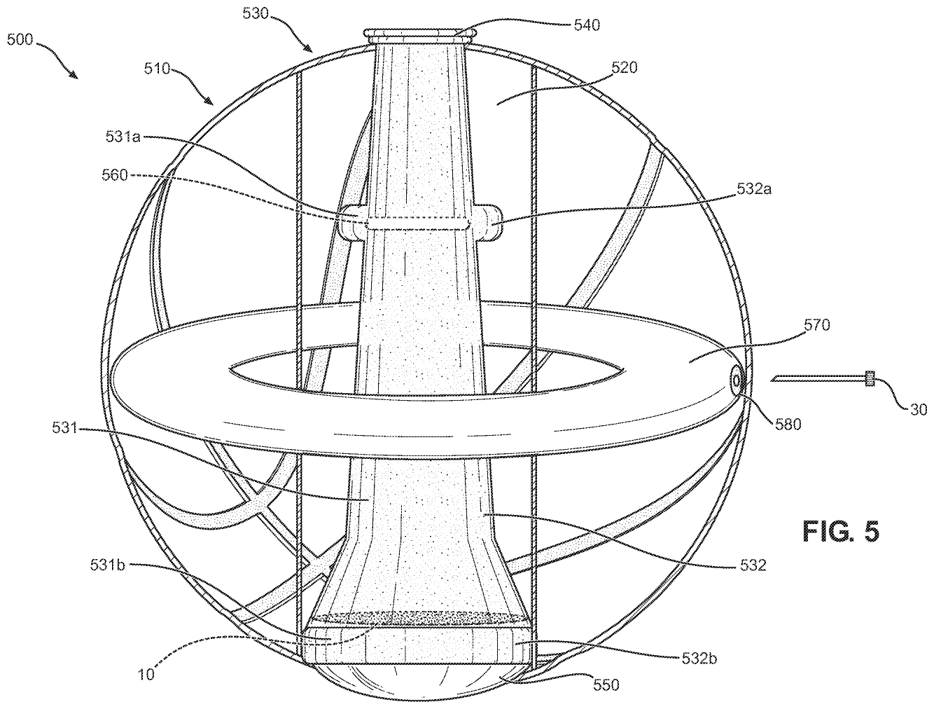

FIG. 5 illustrates a sectional view of a sports article display device 500, according to another exemplary embodiment of the present general inventive concept.

The sports article display device 500 may be constructed from at least one of metal, plastic, wood, glass, and rubber, etc., but is not limited thereto.

The sports article display device 500 may include a main body 510, an inner tube 520, a viewer body 530, an eyepiece 540, a filtering lens 550, a magnification lens 560, an inflatable bladder 570, and an inflation aperture 580, but is not limited thereto.

Referring to FIG. 5, the main body 510 is illustrated to be a basketball. However, the main body 510 may be any type of ball, or any other type of sports article known to one of ordinary skill in the art, but is not limited thereto.

The main body 510 may be spherical. Additionally, the main body 510 may roll across an external surface (e.g., a ground surface, a wall) in response to an application of force (e.g., pushing, pulling) thereto.

The inner tube 520 may be elongate and/or have a cylindrical shape. However, the inner tube 520 may be rectangular, circular, triangular, pentagonal, hexagonal, heptagonal, octagonal, or any other shape known to one of ordinary skill in the art, but is not limited thereto. Additionally, the inner tube 520 may extend at least a portion of a size (e.g., a diameter, a length) of the main body 510.

The inner tube 520 may be disposed within at least a portion of an interior of the main body 510. Moreover, the inner tube 520 may be obscured (i.e., not visible) from an outer surface of the main body 510 and/or an external environment surrounding the main body 510.

The viewer body 530 may be removably disposed (i.e., inserted, attached) within at least a portion of the inner tube 520.

The viewer body 530 may include a first section 531 and a second section 532, but is not limited thereto.

The first section 531 and/or the second section 532 may be removably connected (i.e., clip, clamp, clasp, snap, adhesive (e.g., tape, glue), and/or magnet) to each other. The second section 532 may have a size (e.g., a length, a width, a height) equivalent to a size (e.g., a length, a width, a height) of the first section 531.

The first section 531 may include a first magnifier receiving groove 531a and a first lens receiving groove 531b, but is not limited thereto.

The first magnifier receiving groove 531a may be disposed on at least a portion of the first section 531. The first magnifier receiving groove 531a may protrude away from an outer surface of the first section 531 and be recessed on an interior of the first section 531 corresponding to the protrusion of the first magnifier receiving groove 531a on the outer surface of the first section 531.

The first lens receiving groove 531b may be disposed on at least a portion of a first end of the first section 531. The first lens receiving groove 531b may protrude away from the outer surface of the first section 531 and be recessed on the interior of the first section 531 corresponding to the protrusion of the first lens receiving groove 531b on the outer surface of the first section 531. Also, the first lens receiving groove 531b may be disposed at a distance away from the first magnifier receiving groove 531a.

The second section 532 may include a second magnifier receiving groove 132a and a second lens receiving groove 532b, but is not limited thereto.

The second magnifier receiving groove 532a may be disposed on at least a portion of the second section 532. The second magnifier receiving groove 532a may protrude away from an outer surface of the second section 532 and be recessed on an interior of the second section 532 corresponding to the protrusion of the second magnifier receiving groove 532a on the outer surface of the second section 532.

The second lens receiving groove 532b may be disposed on at least a portion of a first end of the second section 532. The second lens receiving groove 532b may protrude away from the outer surface of the second section 532 and be recessed on the interior of the second section 532 corresponding to the protrusion of the second lens receiving groove 532b on the outer surface of the second section 532. Also, the second lens receiving groove 532b may be disposed at a distance away from the second magnifier receiving groove 532a.

The eyepiece 540 may be removably connected (i.e., clip, clamp, clasp, snap, adhesive (e.g., tape, glue), and/or magnet) to at least a portion of the inner tube 520 and/or a second end of the first section 531 and/or a second end of the second section 532. The eyepiece 540 may include a viewing lens to view contents within the first section 131 and/or the second section 532 by a user. In other words, the eyepiece 540 may facilitate viewing within the first section 531 and/or the second section 532.

The filtering lens 550 may include a transparent optical lens, but is not limited thereto.

The filtering lens 550 may be removably connected (i.e., clip, clamp, clasp, snap, adhesive (e.g., tape, glue), and/or magnet) within the inner tube 520 to at least a portion of the second end of the first section 531 and/or the second end of the second section 532. More specifically, the filtering lens 550 may be removably connected within the first lens receiving groove 531b and/or the second lens receiving groove 532b. In other words, the first section 531 and/or the second section 532 may receive the filtering lens 550 therebetween.

Additionally, the filtering lens 550 may receive a picture 10 thereon, such as a physical photograph, a physical picture, a physical painting, a physical illustration, and/or a physical drawing. During use, the filtering lens 550 may receive light (e.g., sunlight, light source) from the external environment to illuminate the picture 10. Accordingly, the eyepiece 540 may be used to view the picture 10 disposed on the filtering lens 550. As such, the user may view the picture 10 that may be a photograph of a sports player, an athlete, a score sheet from a sports team, a baseball bat, a tennis racket, a football field, and/or any other type of sports related information as desired based on a preference of the user.

The magnification lens 560 may be removably connected (i.e., clip, clamp, clasp, snap, adhesive (e.g., tape, glue), and/or magnet) to at least a portion of the first section 531 and/or the second section 532. More specifically, the magnification lens 560 may be removably connected within the first magnifier receiving groove 531a and/or the second magnifier receiving groove 532a. In other words, the first section 531 and/or the second section 532 may receive the magnification lens 560 therebetween.

The magnification lens 560 may refract light moving therethrough. Moreover, the magnification lens 560 may magnify the picture 10 on the filtering lens 550 while being viewed through the eyepiece 540. As such, the magnification lens 560 may enhance and/or improve viewing of the picture 10 by the user.

The inflatable bladder 570 may have a ring shape to adequately cover the interior of the main body 510.

The inflatable bladder 570 may be disposed on at least a portion of the interior of the main body 510. The inflatable bladder 570 may contact at least a portion of an interior surface of the main body 510. Additionally, the inflatable bladder 570 may prevent compression (i.e., squeezing) of the main body 510 while the inflatable bladder 570 remains at least partially inflated and/or fully inflated in response to an application of force (e.g., striking, bouncing, pushing). In other words, the inflatable bladder 570 may prevent the main body 510 from at least partially deforming while the inflatable bladder 570 contacts the interior surface of the main body 510. Thus, while the main body 510 may deform based on its construction, the inflatable bladder 570 may prevent this from happening. As such, the main body 510 may feel rigid and/or different from the main body 110, the main body 210, the main body 310, and/or the main body 410 as described above. As such, the inflatable bladder 570 may increase a rigidity level of the main body 510. Thus, the inflatable bladder 570 may protect the inner tube 520, the viewer body 530, the eyepiece 540, the filtering lens 550, and/or the magnification lens 560.

The inflation aperture 580 may be disposed on at least a portion of the main body 510 and/or connected to the inflatable bladder 570. The inflation aperture 680 may only be connected to the inflatable bladder 570. The inflation aperture 580 may receive and/or connect to an air supply unit 30 (e.g., a needle, a hose, an air pump) therein. As such, the inflation aperture 580 may facilitate inflation of the inflatable bladder 570 using the air supply unit 30.

Therefore, the sports article display device 500 may allow viewing of the picture 10 while allowing enjoyment of the main body 510 that represents sports memorabilia. Also, the sports article display device 500 may be used for a purpose related to sports without being damaged, such as rolling and/or playing with the main body 510.

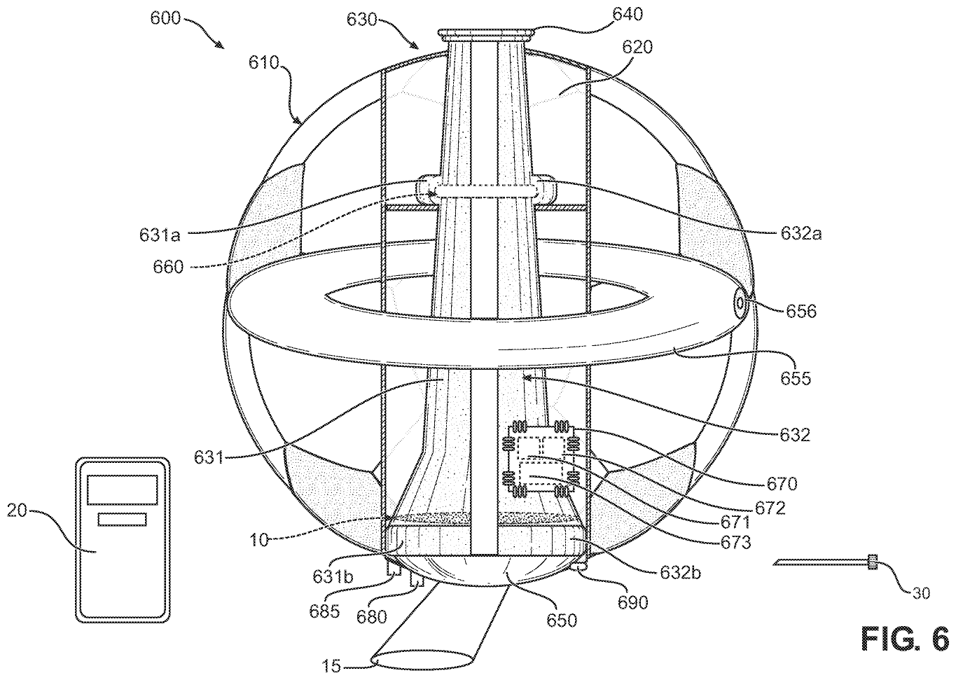

FIG. 6 illustrates a sectional view of a sports article display device 600, according to another exemplary embodiment of the present general inventive concept.

The sports article display device 600 may be constructed from at least one of metal, plastic, wood, glass, and rubber, etc., but is not limited thereto.

The sports article display device 600 may include a main body 610, an inner tube 620, a viewer body 630, an eyepiece 640, a display unit 650, an inflatable bladder 655, an inflation aperture 656, a magnification lens 660, a control unit 670, a connection port 680, and a power source 690, but is not limited thereto.

Referring to FIG. 6, the main body 610 is illustrated to be a soccer ball. However, the main body 610 may be any type of ball, or any other type of sports article known to one of ordinary skill in the art, but is not limited thereto.

The main body 610 may be elastic. More specifically, the main body 610 may at least partially deform in response to an application of force (e.g., pushing, striking) thereto.

The inner tube 620 may be elongate and/or have a cylindrical shape. However, the inner tube 620 may be rectangular, circular, triangular, pentagonal, hexagonal, heptagonal, octagonal, or any other shape known to one of ordinary skill in the art, but is not limited thereto. Additionally, the inner tube 620 may extend at least a portion of a size (e.g., a diameter, a length) of the main body 610.

The inner tube 620 may be disposed within at least a portion of an interior of the main body 610. Moreover, the inner tube 620 may be obscured (i.e., not visible) from an outer surface of the main body 610 and/or an external environment surrounding the main body 610.

The viewer body 630 may be removably disposed (i.e., inserted, attached) within at least a portion of the inner tube 620.

The viewer body 630 may include a first section 631 and a second section 632, but is not limited thereto.

The first section 631 and/or the second section 632 may be removably connected (i.e., clip, clamp, clasp, snap, adhesive (e.g., tape, glue), and/or magnet) to each other. The second section 632 may have a size (e.g., a length, a width, a height) equivalent to a size (e.g., a length, a width, a height) of the first section 631.

The first section 631 may include a first magnifier receiving groove 631a and a first lens receiving groove 631b, but is not limited thereto.

The first magnifier receiving groove 631a may be disposed on at least a portion of the first section 631. The first magnifier receiving groove 631a may protrude away from an outer surface of the first section 631 and be recessed on an interior of the first section 631 corresponding to the protrusion of the first magnifier receiving groove 631a on the outer surface of the first section 631.

The first lens receiving groove 631b may be disposed on at least a portion of a first end of the first section 631. The first lens receiving groove 631b may protrude away from the outer surface of the first section 631 and be recessed on the interior of the first section 631 corresponding to the protrusion of the first lens receiving groove 631b on the outer surface of the first section 631. Also, the first lens receiving groove 631b may be disposed at a distance away from the first magnifier receiving groove 631a.

The second section 632 may include a second magnifier receiving groove 632a and a second lens receiving groove 632b, but is not limited thereto.

The second magnifier receiving groove 632a may be disposed on at least a portion of the second section 632. The second magnifier receiving groove 632a may protrude away from an outer surface of the second section 632 and be recessed on an interior of the second section 632 corresponding to the protrusion of the second magnifier receiving groove 632a on the outer surface of the second section 632.

The second lens receiving groove 632b may be disposed on at least a portion of a first end of the second section 632. The second lens receiving groove 632b may protrude away from the outer surface of the second section 632 and be recessed on the interior of the second section 632 corresponding to the protrusion of the second lens receiving groove 632b on the outer surface of the second section 632. Also, the second lens receiving groove 632b may be disposed at a distance away from the second magnifier receiving groove 632a.

The eyepiece 640 may be removably connected (i.e., clip, clamp, clasp, snap, adhesive (e.g., tape, glue), and/or magnet) to at least a portion of the inner tube 620 and/or a second end of the first section 631 and/or a second end of the second section 632. The eyepiece 640 may include a viewing lens to view contents within the first section 631 and/or the second section 632 by a user. In other words, the eyepiece 640 may facilitate viewing within the first section 631 and/or the second section 632.

The display unit 650 may include a plasma screen, an LCD screen, a light emitting diode (LED) screen, an organic LED (OLED) screen, a computer monitor, a hologram output unit, a sensor (e.g., a weight sensor), a sound outputting unit, or any other type of device that visually or aurally displays data.

The display unit 650 may be removably connected (i.e., clip, clamp, clasp, snap, adhesive (e.g., tape, glue), and/or magnet) to at least a portion of a second end of the inner tube 620 between the first lens receiving groove 631b and/or the second lens receiving groove 632b, and/or within at least a portion of the main body 610. In other words, the first section 631 and/or the second section 632 may receive the display unit 650 therebetween. The display unit 650 may receive a picture 10 thereon, such as a physical photograph, a physical picture, a physical painting, a physical illustration, and/or a physical drawing. During use, the display unit 650 may illuminate the picture 10 to facilitate viewing thereof. Accordingly, the eyepiece 640 may be used to view the picture 10 disposed on the display unit 650. As such, the user may view the picture 10 that may be a photograph of a sports player, an athlete, a score sheet from a sports team, a baseball bat, a tennis racket, a football field, and/or any other type of sports related information as desired based on a preference of the user.

Alternatively, the display unit 650 may display an image 15 thereon, such as a sheet of sports statistics, a digital photograph, a digital painting, a video, a video of a player, a video of a sports game, a non-fungible token (NFT), and/or a digital image. In other words, the display unit 650 may use a screen to display the image 15. Also, the picture 10 may be removed prior to viewing of the image 15. The display unit 650 may detect a presence of the picture 10 thereon.

Accordingly, the eyepiece 640 may be used to view the image 15 displayed on the display unit 650. As such, the user may view the image 15 that may be a photograph of a sports player, an athlete, a score sheet from a sports team, a baseball bat, a tennis racket, a football field, and/or any other type of sports related information as desired based on the preference of the user.

The inflatable bladder 655 may have a ring shape to adequately cover the interior of the main body 610.

The inflatable bladder 655 may be disposed on at least a portion of the interior of the main body 610. The inflatable bladder 655 may contact at least a portion of an interior surface of the main body 610. Additionally, the inflatable bladder 655 may prevent compression (i.e., squeezing) of the main body 610 while the inflatable bladder 655 remains at least partially inflated and/or fully inflated in response to an application of force (e.g., striking, bouncing, pushing). In other words, the inflatable bladder 655 may prevent the main body 610 from at least partially deforming while the inflatable bladder 655 contacts the interior surface of the main body 610. Thus, while the main body 610 may deform based on its construction, the inflatable bladder 655 may prevent this from happening. As such, the main body 610 may feel rigid and/or different from the main body 110, the main body 210, the main body 310, and/or the main body 410 as described above. As such, the inflatable bladder 655 may increase a rigidity level of the main body 610. Thus, the inflatable bladder 655 may protect the inner tube 620, the viewer body 630, the eyepiece 640, the display unit 650, and/or the magnification lens 660.

The inflation aperture 656 may be disposed on at least a portion of the main body 610 and/or connected to the inflatable bladder 655. The inflation aperture 656 may only be connected to the inflatable bladder 655. The inflation aperture 656 may receive and/or connect to an air supply unit 30 (e.g., a needle, a hose, an air pump) therein. As such, the inflation aperture 656 may facilitate inflation of the inflatable bladder 655 using the air supply unit 30.

The magnification lens 660 may be removably connected (i.e., clip, clamp, clasp, snap, adhesive (e.g., tape, glue), and/or magnet) to at least a portion of the first section 631 and/or the second section 632. More specifically, the magnification lens 660 may be removably connected within the first magnifier receiving groove 631a and/or the second magnifier receiving groove 632a. In other words, the first section 631 and/or the second section 632 may receive the magnification lens 660 therebetween.

The magnification lens 660 may refract light moving therethrough. Moreover, the magnification lens 660 may magnify the picture 10 on the display unit 650 while being viewed through the eyepiece 640. As such, the magnification lens 660 may enhance and/or improve viewing of the picture 10 by the user.

Also, the display unit 650 may project the image 15 on the external surface and/or another medium (e.g., a wall, a ground surface, a projector screen, a movie screen, table, etc.) outside a boundary of the main body 610, such that the image 15 is a two-dimensional (2-D) display of the image 15. In other words, the display unit 650 may operate similar to the image projecting unit 440. It is important to note that this substantially differs from the picture 10 used for the sports article display device 200, the sports article display device 200, and/or the sports article display device 300.

Additionally, the display unit 650 may broadcast the image 15 onto an external display, such as a television (TV), a computer monitor, a mobile device, a cell phone, a smart watch, a tablet computer, a laptop computer, a desktop computer, and/or any other type of external display. As such, the image 15 may be viewed on the external display as generated by the display unit 650.

Furthermore, the display unit 650 may project and/or render a holographic display of the image 15 onto the external surface and/or the another medium outside the boundary of the main body 410. Thus, the display unit 650 may create a three-dimensional (3-D) render of the image 15 as a hologram. The display unit 650 displaying the image 15 as the hologram differs from displaying the image 15 as a 2-D image as described above.

The display unit 650 may display the image 15 by saving the image 15 on the external device 20, sharing the image 15 to the external device 20, transmitting the image 15 to the external device 20, and/or uploading the image to the external device 20.

The control unit 670 may be disposed within at least a portion of the inner tube 620 and/or connected to the display unit 650.

The control unit 670 may include a processing unit 671, a communication unit 672, and a storage unit 673, but is not limited thereto.

The processing unit 671 (or central processing unit, CPU) may include electronic circuitry to carry out instructions of a computer program by performing basic arithmetic, logical, control and input/output (I/O) operations specified by the instructions. The processing unit 671 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 671 may also include a microprocessor and a microcontroller.

The communication unit 672 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet.

The storage unit 673 may include a random access memory (RAM), a read-only memory (ROM), a hard disk, a flash drive, a database connected to the Internet, cloud-based storage, Internet-based storage, or any other type of storage unit.

The control unit 670 may access the Internet via the communication unit 672 to allow the user to access a website, and/or may allow a software application to be executed using the processing unit 671. For ease of description, the software application will be hereinafter referred to as an app. The app may be downloaded from the Internet to be stored on the storage unit 673.

The processing unit 671 executing the app may receive and/or retrieve the image 15 from the storage unit 673 to be displayed by the display unit 650. Moreover, the processing unit 671 executing the app may send a variety of and/or a plurality of images 15 to the display unit 650 based on the preference of the user. Accordingly, the display unit 650 may cycle through the plurality of images 15 at a predetermined interval based on instructions received by the processing unit 671 executing the app. The processing unit 671 executing the app may extract image data and/or video data stored on the storage unit 673 to overlay the image data and/or the video data on the image 15 (e.g., an image of the user with a sports player, a player on a field and/or a court of the sports player in a video).

Also, the processing unit 671 executing the app may prevent the display unit 650 from displaying the image 15 while the display unit 650 detects the picture 10 disposed thereon. As such, the processing unit 671 may require the picture 10 to be removed from the display unit 650 prior to the display unit 650 displaying the image 15.

The communication unit 672 may receive an input signal from an external device 20 (e.g., a mobile device, a cell phone, a laptop computer, a desktop computer, a tablet computer, a personal digital assistant (PDA), a smart watch, a cloud computer, a cloud storage device, a network computer) to adjust at least one setting of the processing unit 671 via the app. For example, the processing unit 671 may receive the input signal from the external device 20 to display a single image 15 and/or the plurality of images 15.

Furthermore, the communication unit 672 may receive a signal from the external device 20 to be processed by the processing unit 671 to display the image 15 on the display unit 650. In other words, the display unit 650 may display the image 15 in response to the communication unit 672 receiving the signal from the external device 20. Also, the processing unit 671 may automatically retrieves the image 15 from the external device 20 to be displayed by the display unit 650 in response to the external device 20 moving within a predetermined distance (e.g., one foot, two feet, five feet, ten feet, twenty feet) from the communication unit 672 (e.g., via NFC).

The storage unit 673 may store the single image 15, the plurality of images 15, the at least one setting of the processing unit 671, and/or the app thereon. As such, the processing unit 671 may execute instructions of the app and/or retrieve data stored on the storage unit 673.

The connection port 680 may include a universal serial bus (USB) port, a serial port, a parallel port, a FireWire port, and an Ethernet port, but is not limited thereto.

The connection port 680 may be disposed on and/or within at least a portion of the main body 610. The connection port 680 may receive and/or connect to an external cord therein. For example, the connection port 680 may connect to the external device 20 using the external cord. Alternatively, the connection port 680 may be used to charge the power source 690.

Furthermore, the connection port 680 may be used to receive and/or connect to a flash drive and/or a cloud device. In other words, the processing unit 671 executing the app may extract the image 15 from the flash drive, the cloud device, and/or the external device 20 to be displayed by the display unit 650.

The control panel 685 may include a power button (e.g., on/off button), a menu button, a plurality of scrolling buttons (e.g., an up button, a down button), and an enter button, but is not limited thereto.

The control panel 685 may be disposed on at least a portion of the main body 610. The control panel 685 may turn on the display unit 650, the control unit 670, the connection port 680, and/or the power source 690 in response to depressing the power button a first time. Conversely, the control panel 685 may turn off the display unit 650, the control unit 670, the connection port 680, and/or the power source 690 in response to depressing the power button a second time. Additionally, the control panel 685 may activate a menu on the display unit 650, such that at least one of the plurality of images 15 may be selected. Moreover, the plurality of scrolling buttons of the control panel 685 may be used to select options of the menu on the display unit 650. Lastly, the enter button of the control panel 685 may be used to enter (i.e., confirm) entry of a selection, such as the image 15 to be displayed on the display unit 650.

The external device 20 may perform all function of the control panel 685.

The power source 690 may include a power inlet, a battery, and a solar cell, but is not limited thereto.

The power source 690 may be disposed on and/or within at least a portion of the main body 610. The power source 690 may provide power to the display unit 650, the control unit 670, and/or the connection port 680. The power source 690 may charge the battery in response to receiving power from an external power source (e.g., a power outlet) through the connection port 680 and/or receiving light from an external light source via the solar cell.

Therefore, the sports article display device 600 may allow viewing of the picture 10 while allowing enjoyment of the main body 610 that represents sports memorabilia. Also, the sports article display device 600 may be used for a purpose related to sports.

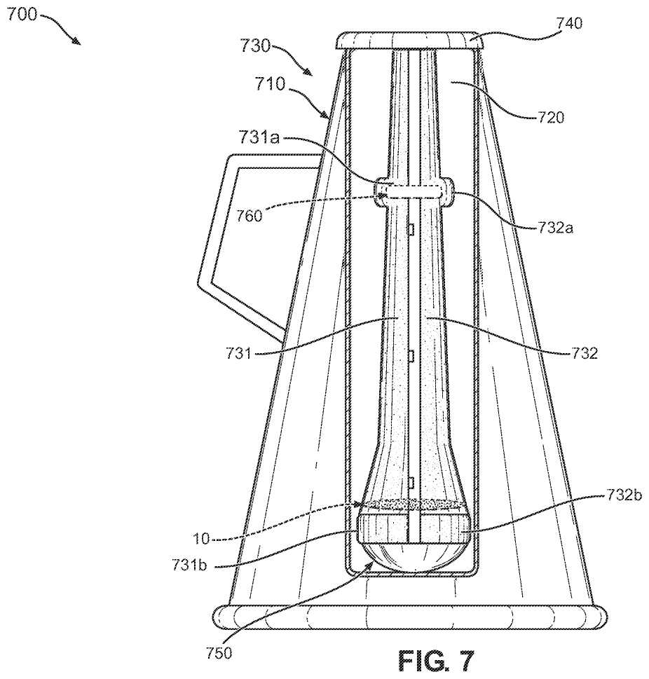

FIG. 7 illustrates a sectional view of a sports article display device 700, according to another exemplary embodiment of the present general inventive concept.

The sports article display device 700 may be constructed from at least one of metal, plastic, wood, glass, and rubber, etc., but is not limited thereto.

The sports article display device 700 may include a main body 710, an inner tube 720, a viewer body 730, an eyepiece 740, a filtering lens 750, and a magnification lens 760, but is not limited thereto.

Referring to FIG. 7, the main body 710 is illustrated to be a megaphone. However, the main body 710 may be any type of horn, microphone, speaker, or any other type of sports article known to one of ordinary skill in the art, but is not limited thereto.

The main body 710 may be trapezoidal. Moreover, the main body 710 may amplify a sound traveling therein. For example, the main body 710 may receive a voice of a user and/or concentrate at least one sound wave therein. Thus, the main body 710 may increase a volume level of the sound therein.

The inner tube 720 may be elongate and/or have a cylindrical shape. However, the inner tube 720 may be rectangular, circular, triangular, pentagonal, hexagonal, heptagonal, octagonal, or any other shape known to one of ordinary skill in the art, but is not limited thereto. Additionally, the inner tube 720 may extend at least a portion of a size (e.g., a diameter, a length) of the main body 710.

The inner tube 720 may be disposed within at least a portion of an interior of the main body 710. Moreover, the inner tube 720 may be obscured (i.e., not visible) from an outer surface of the main body 710 and/or an external environment surrounding the main body 710.

The viewer body 730 may be removably disposed (i.e., inserted, attached) within at least a portion of the inner tube 720.

The viewer body 730 may include a first section 731 and a second section 732, but is not limited thereto.

The first section 731 and/or the second section 732 may be removably connected (i.e., clip, clamp, clasp, snap, adhesive (e.g., tape, glue), and/or magnet) to each other. The second section 732 may have a size (e.g., a length, a width, a height) equivalent to a size (e.g., a length, a width, a height) of the first section 731.

The first section 731 may include a first magnifier receiving groove 731a and a first lens receiving groove 731b, but is not limited thereto.

The first magnifier receiving groove 731a may be disposed on at least a portion of the first section 731. The first magnifier receiving groove 731a may protrude away from an outer surface of the first section 731 and be recessed on an interior of the first section 731 corresponding to the protrusion of the first magnifier receiving groove 731a on the outer surface of the first section 731.

The first lens receiving groove 731b may be disposed on at least a portion of a first end of the first section 731. The first lens receiving groove 731b may protrude away from the outer surface of the first section 731 and be recessed on the interior of the first section 731 corresponding to the protrusion of the first lens receiving groove 731b on the outer surface of the first section 731. Also, the first lens receiving groove 731b may be disposed at a distance away from the first magnifier receiving groove 731a.

The second section 732 may include a second magnifier receiving groove 732a and a second lens receiving groove 732b, but is not limited thereto.

The second magnifier receiving groove 732a may be disposed on at least a portion of the second section 732. The second magnifier receiving groove 732a may protrude away from an outer surface of the second section 732 and be recessed on an interior of the second section 732 corresponding to the protrusion of the second magnifier receiving groove 732a on the outer surface of the second section 732.

The second lens receiving groove 732b may be disposed on at least a portion of a first end of the second section 732. The second lens receiving groove 732b may protrude away from the outer surface of the second section 732 and be recessed on the interior of the second section 732 corresponding to the protrusion of the second lens receiving groove 732b on the outer surface of the second section 732. Also, the second lens receiving groove 732b may be disposed at a distance away from the second magnifier receiving groove 732a.

The eyepiece 740 may be removably connected (i.e., clip, clamp, clasp, snap, adhesive (e.g., tape, glue), and/or magnet) to at least a portion of the inner tube 720 and/or a second end of the first section 731 and/or a second end of the second section 732. The eyepiece 740 may include a viewing lens to view contents within the first section 731 and/or the second section 732 by a user. In other words, the eyepiece 740 may facilitate viewing within the first section 731 and/or the second section 732.

The filtering lens 750 may include a transparent optical lens, but is not limited thereto.

The filtering lens 750 may be removably connected (i.e., clip, clamp, clasp, snap, adhesive (e.g., tape, glue), and/or magnet) within the inner tube 720 to at least a portion of the second end of the first section 731 and/or the second end of the second section 732. More specifically, the filtering lens 750 may be removably connected within the first lens receiving groove 731b and/or the second lens receiving groove 732b. In other words, the first section 731 and/or the second section 732 may receive the filtering lens 740 therebetween.

Additionally, the filtering lens 750 may receive a picture 10 thereon, such as a physical photograph, a physical picture, a physical painting, a physical illustration, and/or a physical drawing. During use, the filtering lens 750 may receive light (e.g., sunlight, light source) from the external environment to illuminate the picture 10. Accordingly, the eyepiece 740 may be used to view the picture 10 disposed on the filtering lens 750. As such, the user may view the picture 10 that may be a photograph of a sports player, an athlete, a score sheet from a sports team, a baseball bat, a tennis racket, a football field, and/or any other type of sports related information as desired based on a preference of the user.

The magnification lens 760 may be removably connected (i.e., clip, clamp, clasp, snap, adhesive (e.g., tape, glue), and/or magnet) to at least a portion of the first section 731 and/or the second section 732. More specifically, the magnification lens 760 may be removably connected within the first magnifier receiving groove 731a and/or the second magnifier receiving groove 732a. In other words, the first section 731 and/or the second section 732 may receive the magnification lens 760 therebetween.

The magnification lens 760 may refract light moving therethrough. Moreover, the magnification lens 760 may magnify the picture 10 on the filtering lens 750 while being viewed through the eyepiece 740. As such, the magnification lens 760 may enhance and/or improve viewing of the picture 10 by the user.

Therefore, the sports article display device 700 may allow viewing of the picture 10 while allowing enjoyment of the main body 710 that represents sports memorabilia. Also, the sports article display device 700 may be used for a purpose related to sports, such as increasing the volume level of the user as a megaphone.

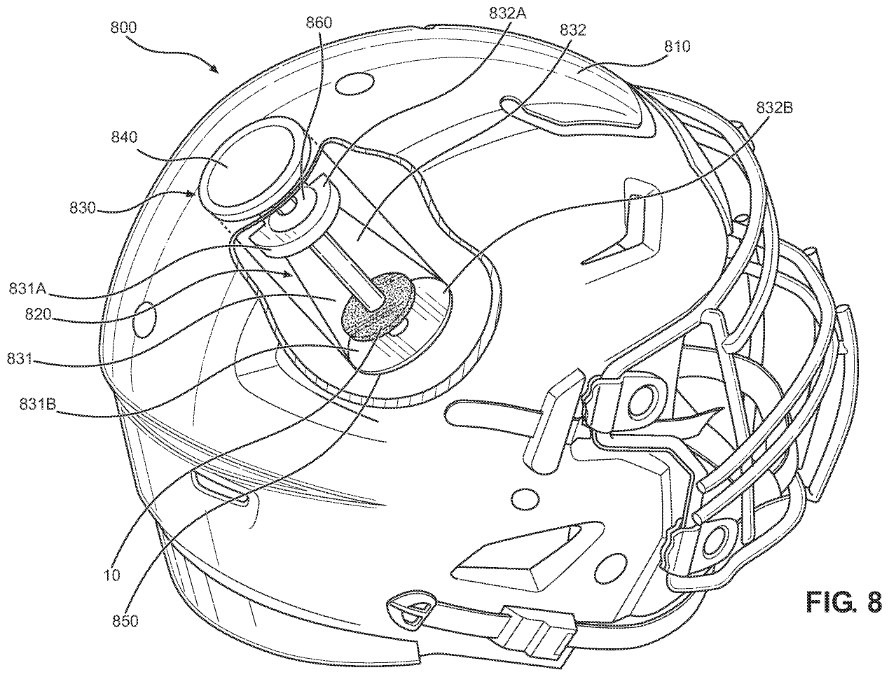

FIG. 8 illustrates a sectional view of a sports article display device 800, according to another exemplary embodiment of the present general inventive concept.

The sports article display device 800 may be constructed from at least one of metal, plastic, wood, glass, and rubber, etc., but is not limited thereto.

The sports article display device 800 may include a main body 810, an inner tube 820, a viewer body 830, an eyepiece 840, a filtering lens 850, and a magnification lens 860, but is not limited thereto.

Referring to FIG. 8, the main body 810 is illustrated to be a football helmet. However, the main body 810 may be any type of helmet and/or headwear, or any other type of sports article known to one of ordinary skill in the art, but is not limited thereto.

The main body 810 may be rigid. Moreover, the main body 810 may prevent damage to a head of a user while being worn. For example, the main body 810 may be worn by the user to protect the head of the user.

The inner tube 820 may be elongate and/or have a cylindrical shape. However, the inner tube 820 may be rectangular, circular, triangular, pentagonal, hexagonal, heptagonal, octagonal, or any other shape known to one of ordinary skill in the art, but is not limited thereto. Additionally, the inner tube 820 may extend at least a portion of a size (e.g., a diameter, a length) of the main body 810.

The inner tube 820 may be disposed within at least a portion of an interior of the main body 810. Moreover, the inner tube 820 may be obscured (i.e., not visible) from an outer surface of the main body 810 and/or an external environment surrounding the main body 810.

The viewer body 830 may be removably disposed (i.e., inserted, attached) within at least a portion of the inner tube 820.

The viewer body 830 may include a first section 831 and a second section 832, but is not limited thereto.

The first section 831 and/or the second section 832 may be removably connected (i.e., clip, clamp, clasp, snap, adhesive (e.g., tape, glue), and/or magnet) to each other. The second section 832 may have a size (e.g., a length, a width, a height) equivalent to a size (e.g., a length, a width, a height) of the first section 831.

The first section 831 may include a first magnifier receiving groove 831a and a first lens receiving groove 831b, but is not limited thereto.

The first magnifier receiving groove 831a may be disposed on at least a portion of the first section 831. The first magnifier receiving groove 831a may protrude away from an outer surface of the first section 831 and be recessed on an interior of the first section 831 corresponding to the protrusion of the first magnifier receiving groove 831a on the outer surface of the first section 831.

The first lens receiving groove 831b may be disposed on at least a portion of a first end of the first section 831. The first lens receiving groove 831b may protrude away from the outer surface of the first section 831 and be recessed on the interior of the first section 831 corresponding to the protrusion of the first lens receiving groove 831b on the outer surface of the first section 831. Also, the first lens receiving groove 831b may be disposed at a distance away from the first magnifier receiving groove 831a.

The second section 832 may include a second magnifier receiving groove 832a and a second lens receiving groove 832b, but is not limited thereto.

The second magnifier receiving groove 832a may be disposed on at least a portion of the second section 832. The second magnifier receiving groove 832a may protrude away from an outer surface of the second section 832 and be recessed on an interior of the second section 832 corresponding to the protrusion of the second magnifier receiving groove 832a on the outer surface of the second section 832.

The second lens receiving groove 832b may be disposed on at least a portion of a first end of the second section 832. The second lens receiving groove 832b may protrude away from the outer surface of the second section 832 and be recessed on the interior of the second section 832 corresponding to the protrusion of the second lens receiving groove 832b on the outer surface of the second section 832. Also, the second lens receiving groove 832b may be disposed at a distance away from the second magnifier receiving groove 832a.

The eyepiece 840 may be removably connected (i.e., clip, clamp, clasp, snap, adhesive (e.g., tape, glue), and/or magnet) to at least a portion of the inner tube 820 and/or a second end of the first section 831 and/or a second end of the second section 832. The eyepiece 840 may include a viewing lens to view contents within the first section 831 and/or the second section 832 by a user. In other words, the eyepiece 840 may facilitate viewing within the first section 831 and/or the second section 832.

The filtering lens 850 may include a transparent optical lens, but is not limited thereto.

The filtering lens 850 may be removably connected (i.e., clip, clamp, clasp, snap, adhesive (e.g., tape, glue), and/or magnet) within the inner tube 820 to at least a portion of the second end of the first section 831 and/or the second end of the second section 832. More specifically, the filtering lens 850 may be removably connected within the first lens receiving groove 831b and/or the second lens receiving groove 832b. In other words, the first section 831 and/or the second section 832 may receive the filtering lens 850 therebetween.

Additionally, the filtering lens 850 may receive a picture 10 thereon, such as a physical photograph, a physical picture, a physical painting, a physical illustration, and/or a physical drawing. During use, the filtering lens 850 may receive light (e.g., sunlight, light source) from the external environment to illuminate the picture 10. Accordingly, the eyepiece 840 may be used to view the picture 10 disposed on the filtering lens 850. As such, the user may view the picture 10 that may be a photograph of a sports player, an athlete, a score sheet from a sports team, a baseball bat, a tennis racket, a football field, and/or any other type of sports related information as desired based on a preference of the user.

The magnification lens 860 may be removably connected (i.e., clip, clamp, clasp, snap, adhesive (e.g., tape, glue), and/or magnet) to at least a portion of the first section 831 and/or the second section 832. More specifically, the magnification lens 860 may be removably connected within the first magnifier receiving groove 831a and/or the second magnifier receiving groove 832a. In other words, the first section 831 and/or the second section 832 may receive the magnification lens 860 therebetween.

The magnification lens 860 may refract light moving therethrough. Moreover, the magnification lens 860 may magnify the picture 10 on the filtering lens 850 while being viewed through the eyepiece 840. As such, the magnification lens 860 may enhance and/or improve viewing of the picture 10 by the user.

Therefore, the sports article display device 800 may allow viewing of the picture 10 while allowing enjoyment of the main body 810 that represents sports memorabilia. Also, the sports article display device 800 may be used for a purpose related to sports without being damaged, such as protecting the head of the user while being worn.

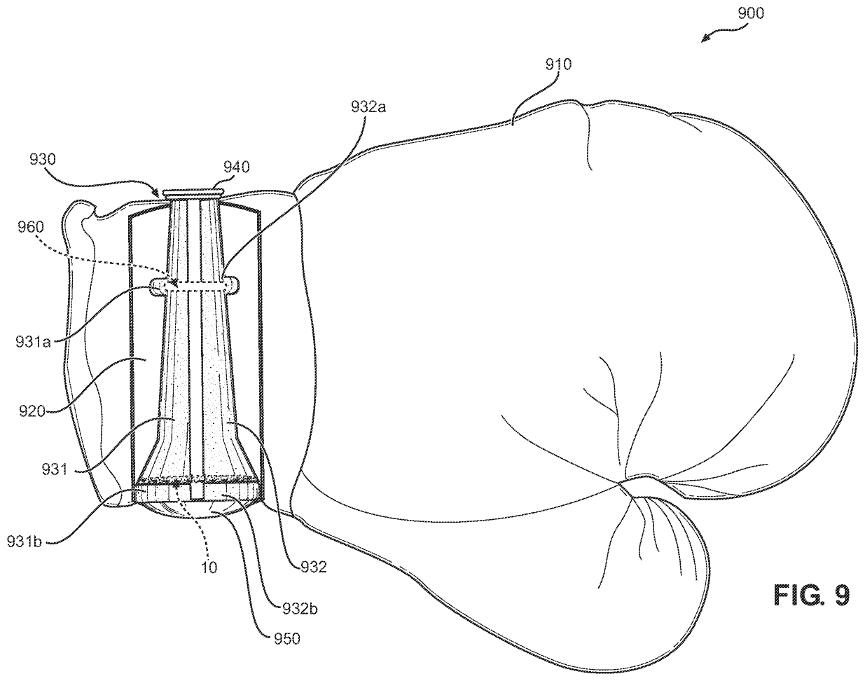

FIG. 9 illustrates a sectional view of a sports article display device 900, according to another exemplary embodiment of the present general inventive concept.

The sports article display device 900 may be constructed from at least one of metal, plastic, wood, glass, and rubber, etc., but is not limited thereto.

The sports article display device 900 may include a main body 910, an inner tube 920, a viewer body 930, an eyepiece 940, a filtering lens 950, and a magnification lens 960, but is not limited thereto.

Referring to FIG. 9, the main body 910 is illustrated to be a boxing glove. However, the main body 910 may be any type of glove, mitten, and/or straps, or any other type of sports article worn on at least a portion of a body (e.g., hands) of the user known to one of ordinary skill in the art, but is not limited thereto. Thus, the main body 910 may protect the hands of the user by absorbing an impact thereon.

The main body 910 may be elastic. More specifically, the main body 910 may at least partially deform (e.g., compress) in response to an application of force (e.g., pushing, striking) thereto. For example, the main body 910 may compress on an external surface (e.g., a person, a punching bag, a wall) in response to striking and/or being in contact with the external surface.

The inner tube 920 may be elongate and/or have a cylindrical shape. However, the inner tube 920 may be rectangular, circular, triangular, pentagonal, hexagonal, heptagonal, octagonal, or any other shape known to one of ordinary skill in the art, but is not limited thereto. Additionally, the inner tube 920 may extend at least a portion of a size (e.g., a diameter, a length) of the main body 910.

The inner tube 920 may be disposed within at least a portion of an interior of the main body 910. Moreover, the inner tube 920 may be obscured (i.e., not visible) from an outer surface of the main body 910 and/or an external environment surrounding the main body 910.

The viewer body 930 may be removably disposed (i.e., inserted, attached) within at least a portion of the inner tube 920.

The viewer body 930 may include a first section 931 and a second section 932, but is not limited thereto.

The first section 931 and/or the second section 932 may be removably connected (i.e., clip, clamp, clasp, snap, adhesive (e.g., tape, glue), and/or magnet) to each other. The second section 932 may have a size (e.g., a length, a width, a height) equivalent to a size (e.g., a length, a width, a height) of the first section 931.

The first section 931 may include a first magnifier receiving groove 931a and a first lens receiving groove 931b, but is not limited thereto.

The first magnifier receiving groove 931a may be disposed on at least a portion of the first section 931. The first magnifier receiving groove 931a may protrude away from an outer surface of the first section 931 and be recessed on an interior of the first section 931 corresponding to the protrusion of the first magnifier receiving groove 931a on the outer surface of the first section 931.

The first lens receiving groove 931b may be disposed on at least a portion of a first end of the first section 931. The first lens receiving groove 931b may protrude away from the outer surface of the first section 931 and be recessed on the interior of the first section 931 corresponding to the protrusion of the first lens receiving groove 931b on the outer surface of the first section 931. Also, the first lens receiving groove 931b may be disposed at a distance away from the first magnifier receiving groove 931a.

The second section 932 may include a second magnifier receiving groove 932a and a second lens receiving groove 932b, but is not limited thereto.

The second magnifier receiving groove 932a may be disposed on at least a portion of the second section 932. The second magnifier receiving groove 932a may protrude away from an outer surface of the second section 932 and be recessed on an interior of the second section 932 corresponding to the protrusion of the second magnifier receiving groove 932a on the outer surface of the second section 932.

The second lens receiving groove 932b may be disposed on at least a portion of a first end of the second section 932. The second lens receiving groove 932b may protrude away from the outer surface of the second section 932 and be recessed on the interior of the second section 932 corresponding to the protrusion of the second lens receiving groove 932b on the outer surface of the second section 932. Also, the second lens receiving groove 932b may be disposed at a distance away from the second magnifier receiving groove 932a.

The eyepiece 940 may be removably connected (i.e., clip, clamp, clasp, snap, adhesive (e.g., tape, glue), and/or magnet) to at least a portion of the inner tube 920 and/or a second end of the first section 931 and/or a second end of the second section 932. The eyepiece 940 may include a viewing lens to view contents within the first section 931 and/or the second section 932 by a user. In other words, the eyepiece 940 may facilitate viewing within the first section 931 and/or the second section 932.

The filtering lens 950 may include a transparent optical lens, but is not limited thereto.

The filtering lens 950 may be removably connected (i.e., clip, clamp, clasp, snap, adhesive (e.g., tape, glue), and/or magnet) within the inner tube 920 to at least a portion of the second end of the first section 931 and/or the second end of the second section 932. More specifically, the filtering lens 950 may be removably connected within the first lens receiving groove 931b and/or the second lens receiving groove 932b. In other words, the first section 931 and/or the second section 932 may receive the filtering lens 950 therebetween.

Additionally, the filtering lens 950 may receive a picture 10 thereon, such as a physical photograph, a physical picture, a physical painting, a physical illustration, and/or a physical drawing. During use, the filtering lens 950 may receive light (e.g., sunlight, light source) from the external environment to illuminate the picture 10. Accordingly, the eyepiece 940 may be used to view the picture 10 disposed on the filtering lens 950. As such, the user may view the picture 10 that may be a photograph of a sports player, an athlete, a score sheet from a sports team, a baseball bat, a tennis racket, a football field, and/or any other type of sports related information as desired based on a preference of the user.

The magnification lens 960 may be removably connected (i.e., clip, clamp, clasp, snap, adhesive (e.g., tape, glue), and/or magnet) to at least a portion of the first section 931 and/or the second section 932. More specifically, the magnification lens 960 may be removably connected within the first magnifier receiving groove 931a and/or the second magnifier receiving groove 932a. In other words, the first section 931 and/or the second section 932 may receive the magnification lens 960 therebetween.

The magnification lens 960 may refract light moving therethrough. Moreover, the magnification lens 960 may magnify the picture 10 on the filtering lens 950 while being viewed through the eyepiece 940. As such, the magnification lens 960 may enhance and/or improve viewing of the picture 10 by the user.

Therefore, the sports article display device 900 may allow viewing of the picture 10 while allowing enjoyment of the main body 910 that represents sports memorabilia. Also, the sports article display device 900 may be used for a purpose related to sports without being damaged, such as protecting the hand of the user while being worn.

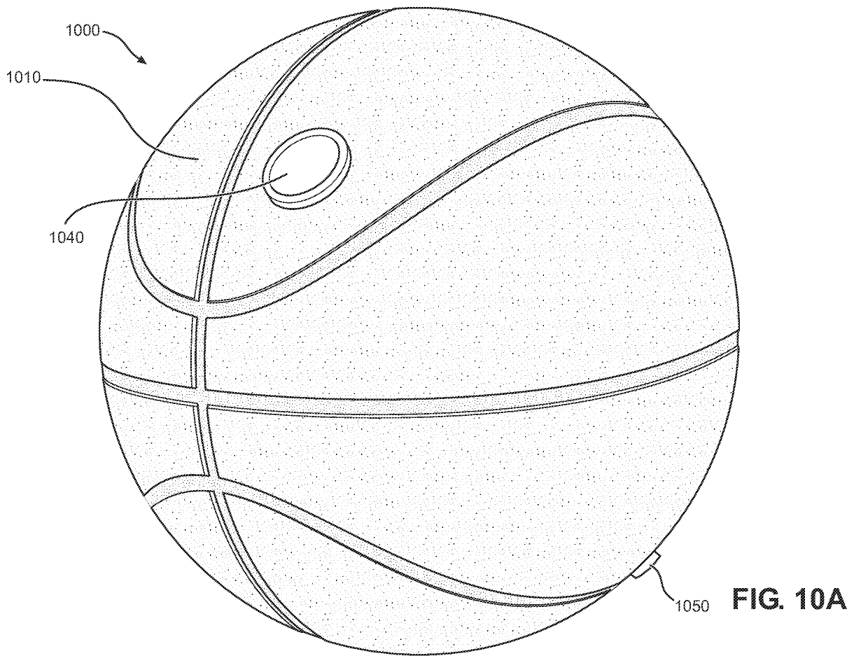

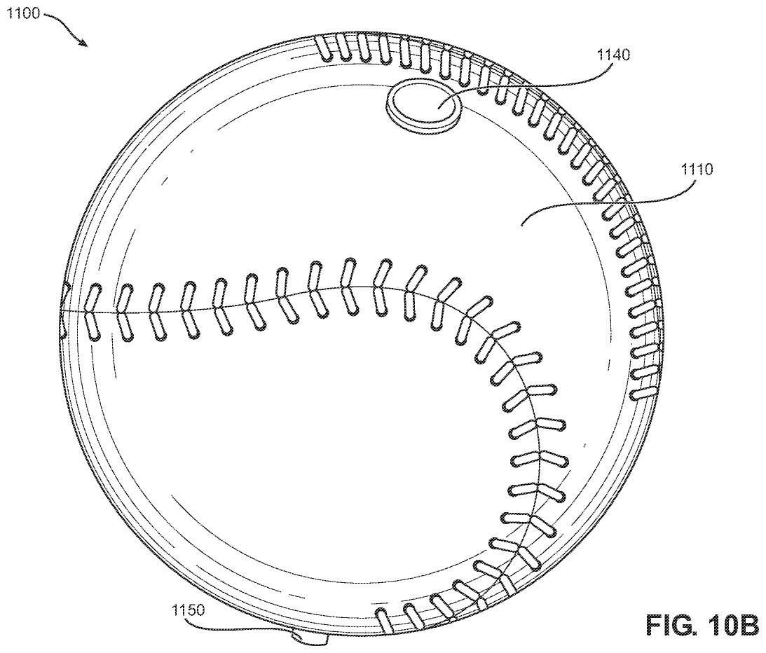

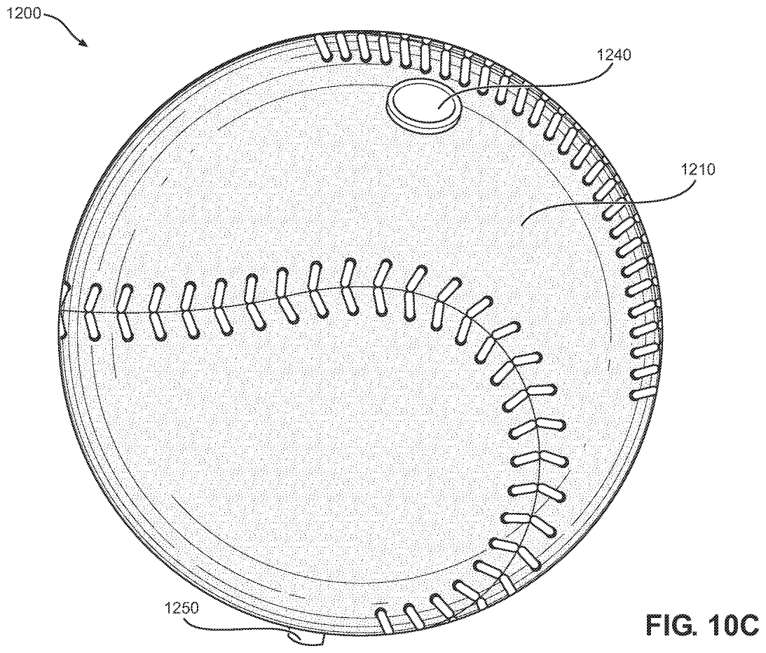

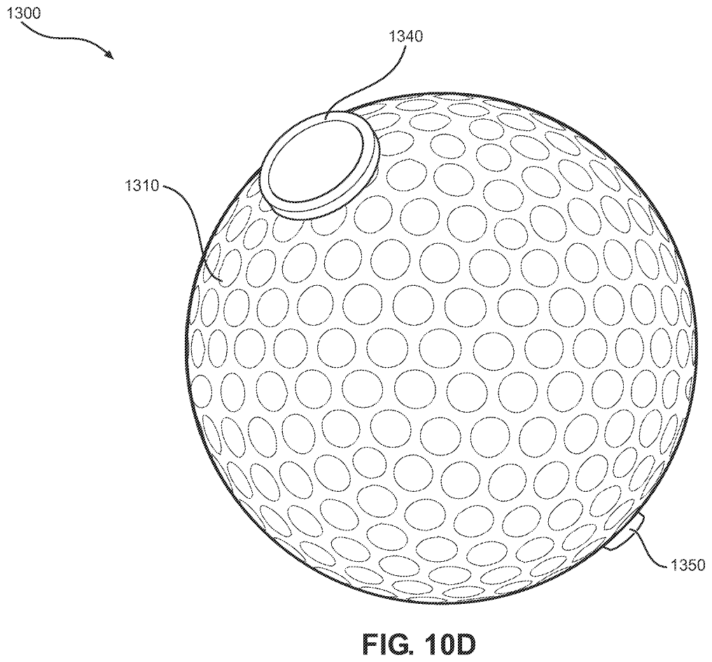

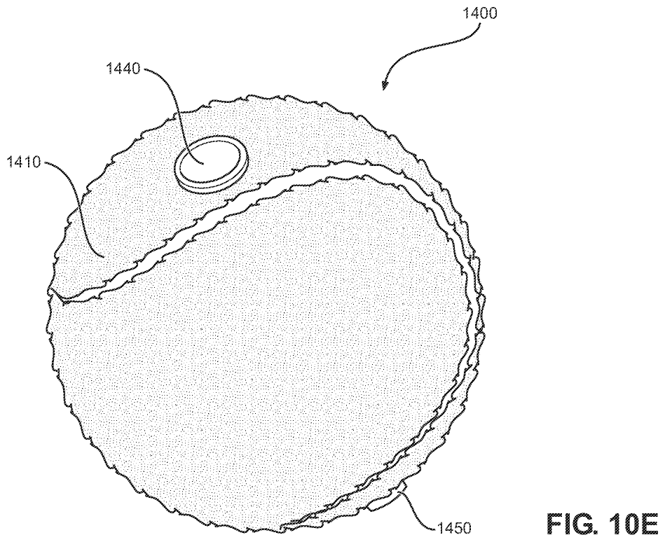

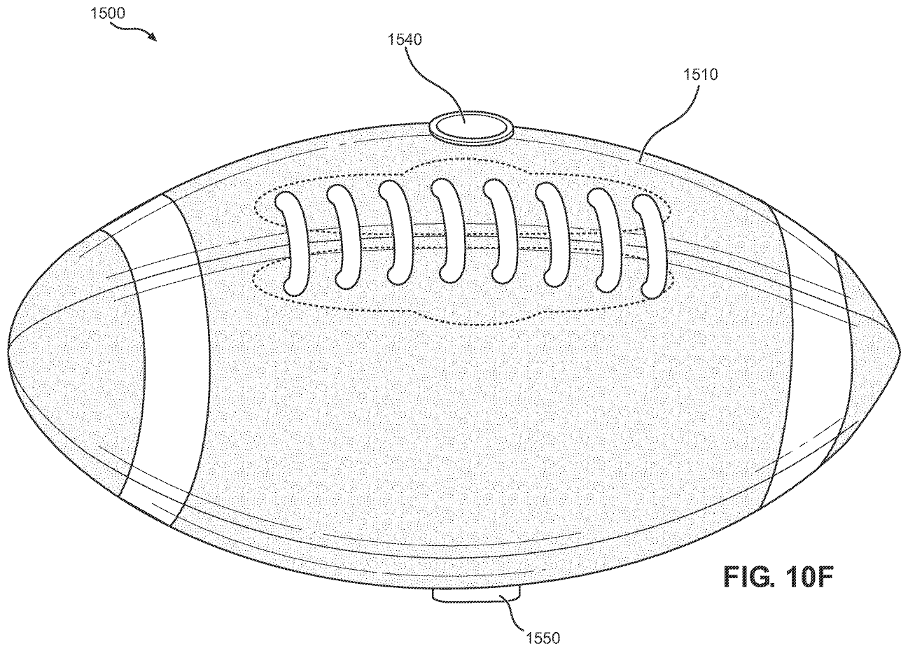

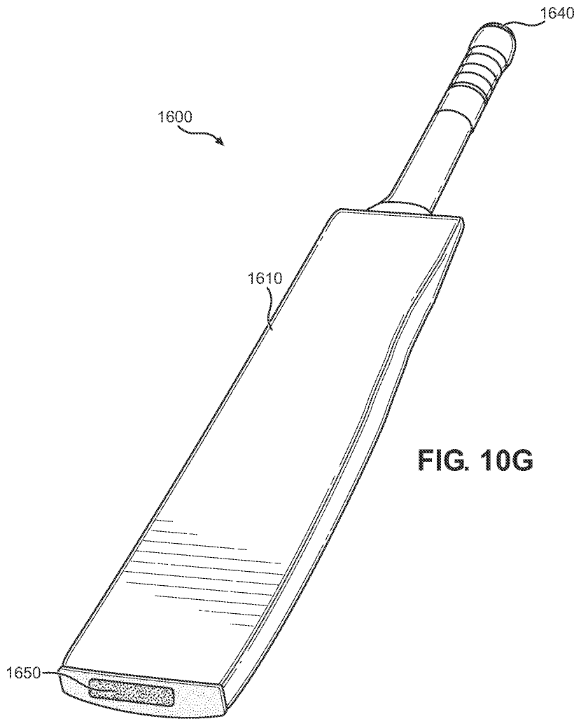

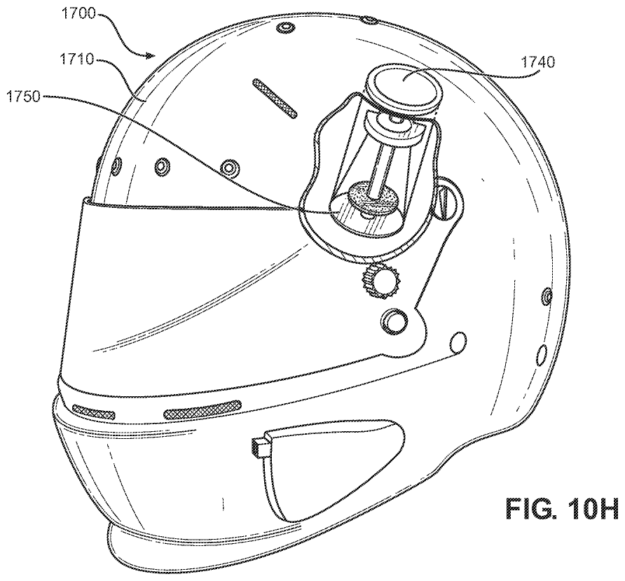

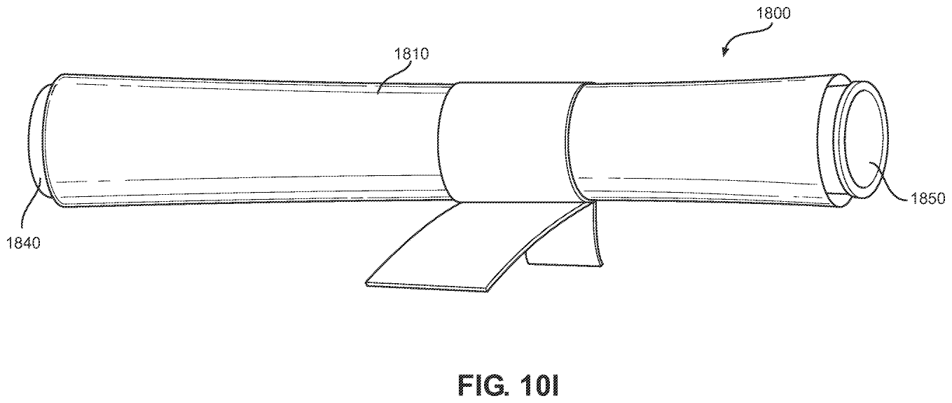

FIG. 10A illustrates a perspective view of a sports article display device 1000, according to another exemplary embodiment of the present general inventive concept.

The sports article display device 1000 may be constructed from at least one of metal, plastic, wood, glass, and rubber, etc., but is not limited thereto.

The sports article display device 1000 may include a main body 1010, an eyepiece 1040, and a filtering lens 1050, but is not limited thereto.

Referring to FIG. 10A, the main body 1010 is illustrated to be a basketball. However, the main body 1010 may be any type of ball, or any other type of sports article known to one of ordinary skill in the art, but is not limited thereto. Also, the main body 1010 may have any size and/or shape based on a preference of the user for a sports object, or any other type of object for that matter, including but not limited to a baseball bat, a hockey stick, a hockey puck, a goal post, a volleyball net, a balance beam, a skate, a rollerblade, a punching bag, a barbell, a dumbbell, a golf club, a tennis racket, a ring, a computer, a laptop, a box, a fishbowl, a sword, a shield, a microphone, and/or a firearm.

The main body 1010 may be elastic. More specifically, the main body 1010 may at least partially deform in response to an application of force (e.g., pushing, striking) thereto.

The eyepiece 1040 may be removably connected (i.e., clip, clamp, clasp, snap, adhesive (e.g., tape, glue), and/or magnet) to at least a portion of the main body 1010. The eyepiece 1040 may include a viewing lens to view contents within the main body 1010 by a user. In other words, the eyepiece 1040 may facilitate viewing within the main body 1010.

The filtering lens 1050 may include a transparent optical lens, but is not limited thereto.

The filtering lens 1050 may be removably connected (i.e., clip, clamp, clasp, snap, adhesive (e.g., tape, glue), and/or magnet) to at least a portion of the main body 1010. More specifically, the filtering lens 1050 may be removably connected within the main body 1010.

Additionally, the filtering lens 1050 may receive a picture 10 thereon, such as a physical photograph, a physical picture, a physical painting, a physical illustration, and/or a physical drawing. During use, the filtering lens 1050 may receive light (e.g., sunlight, light source) from the external environment to illuminate the picture 10. Accordingly, the eyepiece 1040 may be used to view the picture 10 disposed on the filtering lens 1050. As such, the user may view the picture 10 that may be a photograph of a sports player, an athlete, a score sheet from a sports team, a baseball bat, a tennis racket, a football field, and/or any other type of sports related information as desired based on a preference of the user.

While not specifically illustrated in FIG. 10A, the sports article display device 1000 may further include any of the components described above with respect to the sports article display device 100, the sports article display device 200, the sports article display device 300, the sports article display device 400, the sports article display device 500, the sports article display device 600, the sports article display device 700, the sports article display device 800, and/or the sports article display device 900.

Therefore, the sports article display device 1000 may allow viewing of the picture 10 while allowing enjoyment of the main body 1010 that represents sports memorabilia. Also, the sports article display device 1000 may be used for a purpose related to sports.

FIG. 10B illustrates a perspective view of a sports article display device 1100, according to another exemplary embodiment of the present general inventive concept.

The sports article display device 1100 may be constructed from at least one of metal, plastic, wood, glass, and rubber, etc., but is not limited thereto.

The sports article display device 1100 may include a main body 1110, an eyepiece 1140, and a filtering lens 1150, but is not limited thereto.

Referring to FIG. 10B, the main body 1110 is illustrated to be a baseball. However, the main body 1110 may be any type of ball, or any other type of sports article known to one of ordinary skill in the art, but is not limited thereto. Also, the main body 1110 may have any size and/or shape based on a preference of the user for a sports object, including but not limited to a baseball bat, a hockey stick, a hockey puck, a goal post, a volleyball net, a baseball glove, a balance beam, a skate, a rollerblade, a punching bag, a barbell, a dumbbell, a golf club, and/or a tennis racket.

The main body 1110 may be elastic. More specifically, the main body 1110 may at least partially deform in response to an application of force (e.g., pushing, striking) thereto.

The eyepiece 1140 may be removably connected (i.e., clip, clamp, clasp, snap, adhesive (e.g., tape, glue), and/or magnet) to at least a portion of the main body 1110. The eyepiece 1140 may include a viewing lens to view contents within the main body 1110 by a user. In other words, the eyepiece 1140 may facilitate viewing within the main body 1110.

The filtering lens 1150 may include a transparent optical lens, but is not limited thereto.

The filtering lens 1150 may be removably connected (i.e., clip, clamp, clasp, snap, adhesive (e.g., tape, glue), and/or magnet) to at least a portion of the main body 1110. More specifically, the filtering lens 1150 may be removably connected within the main body 1110.

Additionally, the filtering lens 1150 may receive a picture 10 thereon, such as a physical photograph, a physical picture, a physical painting, a physical illustration, and/or a physical drawing. During use, the filtering lens 1150 may receive light (e.g., sunlight, light source) from the external environment to illuminate the picture 10. Accordingly, the eyepiece 1140 may be used to view the picture 10 disposed on the filtering lens 1150. As such, the user may view the picture 10 that may be a photograph of a sports player, an athlete, a score sheet from a sports team, a baseball bat, a tennis racket, a football field, and/or any other type of sports related information as desired based on a preference of the user.

While not specifically illustrated in FIG. 10B, the sports article display device 1100 may further include any of the components described above with respect to the sports article display device 100, the sports article display device 200, the sports article display device 300, the sports article display device 400, the sports article display device 500, the sports article display device 600, the sports article display device 700, the sports article display device 800, and/or the sports article display device 900.

Therefore, the sports article display device 1100 may allow viewing of the picture 10 while allowing enjoyment of the main body 1110 that represents sports memorabilia. Also, the sports article display device 1100 may be used for a purpose related to sports.

FIG. 10C illustrates a perspective view of a sports article display device 1200, according to another exemplary embodiment of the present general inventive concept.

The sports article display device 1200 may be constructed from at least one of metal, plastic, wood, glass, and rubber, etc., but is not limited thereto.

The sports article display device 1200 may include a main body 1210, an eyepiece 1240, and a filtering lens 1250, but is not limited thereto.

Referring to FIG. 10C, the main body 1210 is illustrated to be a softball. However, the main body 1210 may be any type of ball, or any other type of sports article known to one of ordinary skill in the art, but is not limited thereto. Also, the main body 1210 may have any size and/or shape based on a preference of the user for a sports object, including but not limited to a baseball bat, a hockey stick, a hockey puck, a goal post, a volleyball net, a baseball glove, a balance beam, a skate, a rollerblade, a punching bag, a barbell, a dumbbell, a golf club, and/or a tennis racket.

The main body 1210 may be elastic. More specifically, the main body 1210 may at least partially deform in response to an application of force (e.g., pushing, striking) thereto.

The eyepiece 1240 may be removably connected (i.e., clip, clamp, clasp, snap, adhesive (e.g., tape, glue), and/or magnet) to at least a portion of the main body 1210. The eyepiece 1240 may include a viewing lens to view contents within the main body 1210 by a user. In other words, the eyepiece 1240 may facilitate viewing within the main body 1210.

The filtering lens 1250 may include a transparent optical lens, but is not limited thereto.

The filtering lens 1250 may be removably connected (i.e., clip, clamp, clasp, snap, adhesive (e.g., tape, glue), and/or magnet) to at least a portion of the main body 1210. More specifically, the filtering lens 1250 may be removably connected within the main body 1210.

Additionally, the filtering lens 1250 may receive a picture 10 thereon, such as a physical photograph, a physical picture, a physical painting, a physical illustration, and/or a physical drawing. During use, the filtering lens 1250 may receive light (e.g., sunlight, light source) from the external environment to illuminate the picture 10. Accordingly, the eyepiece 1240 may be used to view the picture 10 disposed on the filtering lens 1250. As such, the user may view the picture 10 that may be a photograph of a sports player, an athlete, a score sheet from a sports team, a baseball bat, a tennis racket, a football field, and/or any other type of sports related information as desired based on a preference of the user.

While not specifically illustrated in FIG. 10C, the sports article display device 1200 may further include any of the components described above with respect to the sports article display device 100, the sports article display device 200, the sports article display device 300, the sports article display device 400, the sports article display device 500, the sports article display device 600, the sports article display device 700, the sports article display device 800, and/or the sports article display device 900.

Therefore, the sports article display device 1200 may allow viewing of the picture 10 while allowing enjoyment of the main body 1210 that represents sports memorabilia. Also, the sports article display device 1200 may be used for a purpose related to sports.

FIG. 10D illustrates a perspective view of a sports article display device 1300, according to another exemplary embodiment of the present general inventive concept.

The sports article display device 1300 may be constructed from at least one of metal, plastic, wood, glass, and rubber, etc., but is not limited thereto.

The sports article display device 1300 may include a main body 1310, an eyepiece 1340, and a filtering lens 1350, but is not limited thereto.

Referring to FIG. 10D, the main body 1310 is illustrated to be a golf ball. However, the main body 1310 may be any type of ball, or any other type of sports article known to one of ordinary skill in the art, but is not limited thereto. Also, the main body 1310 may have any size and/or shape based on a preference of the user for a sports object, including but not limited to a baseball bat, a hockey stick, a hockey puck, a goal post, a volleyball net, a baseball glove, a balance beam, a skate, a rollerblade, a punching bag, a barbell, a dumbbell, a golf club, and/or a tennis racket.

The main body 1310 may be elastic. More specifically, the main body 1310 may at least partially deform in response to an application of force (e.g., pushing, striking) thereto.

The eyepiece 1340 may be removably connected (i.e., clip, clamp, clasp, snap, adhesive (e.g., tape, glue), and/or magnet) to at least a portion of the main body 1310. The eyepiece 1340 may include a viewing lens to view contents within the main body 1310 by a user. In other words, the eyepiece 1340 may facilitate viewing within the main body 1310.

The filtering lens 1350 may include a transparent optical lens, but is not limited thereto.

The filtering lens 1350 may be removably connected (i.e., clip, clamp, clasp, snap, adhesive (e.g., tape, glue), and/or magnet) to at least a portion of the main body 1310. More specifically, the filtering lens 1350 may be removably connected within the main body 1310.

Additionally, the filtering lens 1350 may receive a picture 10 thereon, such as a physical photograph, a physical picture, a physical painting, a physical illustration, and/or a physical drawing. During use, the filtering lens 1350 may receive light (e.g., sunlight, light source) from the external environment to illuminate the picture 10. Accordingly, the eyepiece 1340 may be used to view the picture 10 disposed on the filtering lens 1350. As such, the user may view the picture 10 that may be a photograph of a sports player, an athlete, a score sheet from a sports team, a baseball bat, a tennis racket, a football field, and/or any other type of sports related information as desired based on a preference of the user.

While not specifically illustrated in FIG. 10D, the sports article display device 1300 may further include any of the components described above with respect to the sports article display device 100, the sports article display device 200, the sports article display device 300, the sports article display device 400, the sports article display device 500, the sports article display device 600, the sports article display device 700, the sports article display device 800, and/or the sports article display device 900.

Therefore, the sports article display device 1300 may allow viewing of the picture 10 while allowing enjoyment of the main body 1310 that represents sports memorabilia. Also, the sports article display device 1300 may be used for a purpose related to sports.

FIG. 10E illustrates a perspective view of a sports article display device 1400, according to another exemplary embodiment of the present general inventive concept.

The sports article display device 1400 may be constructed from at least one of metal, plastic, wood, glass, and rubber, etc., but is not limited thereto.

The sports article display device 1400 may include a main body 1410, an eyepiece 1440, and a filtering lens 1450, but is not limited thereto.

Referring to FIG. 10E, the main body 1410 is illustrated to be a tennis ball. However, the main body 1410 may be any type of ball, or any other type of sports article known to one of ordinary skill in the art, but is not limited thereto. Also, the main body 1410 may have any size and/or shape based on a preference of the user for a sports object, including but not limited to a baseball bat, a hockey stick, a hockey puck, a goal post, a volleyball net, a baseball glove, a balance beam, a skate, a rollerblade, a punching bag, a barbell, a dumbbell, a golf club, and/or a tennis racket.

The main body 1410 may be elastic. More specifically, the main body 1410 may at least partially deform in response to an application of force (e.g., pushing, striking) thereto.

The eyepiece 1440 may be removably connected (i.e., clip, clamp, clasp, snap, adhesive (e.g., tape, glue), and/or magnet) to at least a portion of the main body 1410. The eyepiece 1440 may include a viewing lens to view contents within the main body 1410 by a user. In other words, the eyepiece 1440 may facilitate viewing within the main body 1410.

The filtering lens 1450 may include a transparent optical lens, but is not limited thereto.

The filtering lens 1450 may be removably connected (i.e., clip, clamp, clasp, snap, adhesive (e.g., tape, glue), and/or magnet) to at least a portion of the main body 1410. More specifically, the filtering lens 1450 may be removably connected within the main body 1410.

Additionally, the filtering lens 1450 may receive a picture 10 thereon, such as a physical photograph, a physical picture, a physical painting, a physical illustration, and/or a physical drawing. During use, the filtering lens 1450 may receive light (e.g., sunlight, light source) from the external environment to illuminate the picture 10. Accordingly, the eyepiece 1440 may be used to view the picture 10 disposed on the filtering lens 1450. As such, the user may view the picture 10 that may be a photograph of a sports player, an athlete, a score sheet from a sports team, a baseball bat, a tennis racket, a football field, and/or any other type of sports related information as desired based on a preference of the user.

While not specifically illustrated in FIG. 10E, the sports article display device 1400 may further include any of the components described above with respect to the sports article display device 100, the sports article display device 200, the sports article display device 300, the sports article display device 400, the sports article display device 500, the sports article display device 600, the sports article display device 700, the sports article display device 800, and/or the sports article display device 900.

Therefore, the sports article display device 1400 may allow viewing of the picture 10 while allowing enjoyment of the main body 1410 that represents sports memorabilia. Also, the sports article display device 1400 may be used for a purpose related to sports.

FIG. 10F illustrates a perspective view of a sports article display device 1500, according to another exemplary embodiment of the present general inventive concept.

The sports article display device 1500 may be constructed from at least one of metal, plastic, wood, glass, and rubber, etc., but is not limited thereto.

The sports article display device 1500 may include a main body 1510, an eyepiece 1540, and a filtering lens 1550, but is not limited thereto.

Referring to FIG. 10F, the main body 1510 is illustrated to be a football. However, the main body 1510 may be any type of ball, or any other type of sports article known to one of ordinary skill in the art, but is not limited thereto. Also, the main body 1510 may have any size and/or shape based on a preference of the user for a sports object, including but not limited to a baseball bat, a hockey stick, a hockey puck, a goal post, a volleyball net, a baseball glove, a balance beam, a skate, a rollerblade, a punching bag, a barbell, a dumbbell, a golf club, and/or a tennis racket.

The main body 1510 may be elastic. More specifically, the main body 1510 may at least partially deform in response to an application of force (e.g., pushing, striking) thereto.

The eyepiece 1540 may be removably connected (i.e., clip, clamp, clasp, snap, adhesive (e.g., tape, glue), and/or magnet) to at least a portion of the main body 1510. The eyepiece 1540 may include a viewing lens to view contents within the main body 1510 by a user. In other words, the eyepiece 1540 may facilitate viewing within the main body 1510.

The filtering lens 1550 may include a transparent optical lens, but is not limited thereto.

The filtering lens 1550 may be removably connected (i.e., clip, clamp, clasp, snap, adhesive (e.g., tape, glue), and/or magnet) to at least a portion of the main body 1510. More specifically, the filtering lens 1550 may be removably connected within the main body 1510.

Additionally, the filtering lens 1550 may receive a picture 10 thereon, such as a physical photograph, a physical picture, a physical painting, a physical illustration, and/or a physical drawing. During use, the filtering lens 1550 may receive light (e.g., sunlight, light source) from the external environment to illuminate the picture 10. Accordingly, the eyepiece 1540 may be used to view the picture 10 disposed on the filtering lens 1550. As such, the user may view the picture 10 that may be a photograph of a sports player, an athlete, a score sheet from a sports team, a baseball bat, a tennis racket, a football field, and/or any other type of sports related information as desired based on a preference of the user.

While not specifically illustrated in FIG. 10F, the sports article display device 1500 may further include any of the components described above with respect to the sports article display device 100, the sports article display device 200, the sports article display device 300, the sports article display device 400, the sports article display device 500, the sports article display device 600, the sports article display device 700, the sports article display device 800, and/or the sports article display device 900.

Therefore, the sports article display device 1500 may allow viewing of the picture 10 while allowing enjoyment of the main body 1510 that represents sports memorabilia. Also, the sports article display device 1500 may be used for a purpose related to sports.

FIG. 10G illustrates a perspective view of a sports article display device 1600, according to another exemplary embodiment of the present general inventive concept.

The sports article display device 1600 may be constructed from at least one of metal, plastic, wood, glass, and rubber, etc., but is not limited thereto.

The sports article display device 1600 may include a main body 1610, an eyepiece 1640, and a filtering lens 1650, but is not limited thereto.

Referring to FIG. 10G, the main body 1610 is illustrated to be a cricket bat. However, the main body 1610 may be any type of bat, or any other type of sports article known to one of ordinary skill in the art, but is not limited thereto. Also, the main body 1610 may have any size and/or shape based on a preference of the user for a sports object, including but not limited to a baseball bat, a hockey stick, a hockey puck, a goal post, a volleyball net, a baseball glove, a balance beam, a skate, a rollerblade, a punching bag, a barbell, a dumbbell, a golf club, and/or a tennis racket.

The main body 1610 may be constructed of cork wrapped in string and covered with leather. As such, the main body 1610 may be rigid and/or solid. More specifically, the main body 1610 may at least partially move (e.g., roll) in response to an application of force (e.g., pushing, pulling) thereto. For example, the main body 1610 may roll on an external surface (e.g., a ground surface, a wall) in response to being thrown, dropped, hit, and/or otherwise moved toward the external surface.

The eyepiece 1640 may be removably connected (i.e., clip, clamp, clasp, snap, adhesive (e.g., tape, glue), and/or magnet) to at least a portion of the main body 1610. The eyepiece 1640 may include a viewing lens to view contents within the main body 1610 by a user. In other words, the eyepiece 1640 may facilitate viewing within the main body 1610.

The filtering lens 1650 may include a transparent optical lens, but is not limited thereto.

The filtering lens 1650 may be removably connected (i.e., clip, clamp, clasp, snap, adhesive (e.g., tape, glue), and/or magnet) to at least a portion of the main body 1610. More specifically, the filtering lens 1650 may be removably connected within the main body 1610.

Additionally, the filtering lens 1650 may receive a picture 10 thereon, such as a physical photograph, a physical picture, a physical painting, a physical illustration, and/or a physical drawing. During use, the filtering lens 1650 may receive light (e.g., sunlight, light source) from the external environment to illuminate the picture 10. Accordingly, the eyepiece 1640 may be used to view the picture 10 disposed on the filtering lens 1650. As such, the user may view the picture 10 that may be a photograph of a sports player, an athlete, a score sheet from a sports team, a baseball bat, a tennis racket, a football field, and/or any other type of sports related information as desired based on a preference of the user.

While not specifically illustrated in FIG. 10G, the sports article display device 1600 may further include any of the components described above with respect to the sports article display device 100, the sports article display device 200, the sports article display device 300, the sports article display device 400, the sports article display device 500, the sports article display device 600, the sports article display device 700, the sports article display device 800, and/or the sports article display device 900.

Therefore, the sports article display device 1600 may allow viewing of the picture 10 while allowing enjoyment of the main body 1610 that represents sports memorabilia. Also, the sports article display device 1600 may be used for a purpose related to sports.

FIG. 10H illustrates a perspective view of a sports article display device 1700, according to another exemplary embodiment of the present general inventive concept.

The sports article display device 1700 may be constructed from at least one of metal, plastic, wood, glass, and rubber, etc., but is not limited thereto.

The sports article display device 1700 may include a main body 1710, an eyepiece 1740, and a filtering lens 1750, but is not limited thereto.

Referring to FIG. 10H, the main body 1710 is illustrated to be a racing helmet. However, the main body 1710 may be any type of helmet and/or headwear, or any other type of sports article known to one of ordinary skill in the art, but is not limited thereto. Also, the main body 1710 may have any size and/or shape based on a preference of the user for a sports object, including but not limited to a baseball bat, a hockey stick, a hockey puck, a goal post, a volleyball net, a baseball glove, a balance beam, a skate, a rollerblade, a punching bag, a barbell, a dumbbell, a golf club, and/or a tennis racket.

The main body 1710 may be rigid. Moreover, the main body 1710 may prevent damage to a head of a user while being worn. For example, the main body 1710 may be worn by the user to protect the head of the user.

The eyepiece 1740 may be removably connected (i.e., clip, clamp, clasp, snap, adhesive (e.g., tape, glue), and/or magnet) to at least a portion of the main body 1710. The eyepiece 1740 may include a viewing lens to view contents within the main body 1710 by a user. In other words, the eyepiece 1740 may facilitate viewing within the main body 1710.

The filtering lens 1750 may include a transparent optical lens, but is not limited thereto.

The filtering lens 1750 may be removably connected (i.e., clip, clamp, clasp, snap, adhesive (e.g., tape, glue), and/or magnet) to at least a portion of the main body 1710. More specifically, the filtering lens 1750 may be removably connected within the main body 1710.

Additionally, the filtering lens 1750 may receive a picture 10 thereon, such as a physical photograph, a physical picture, a physical painting, a physical illustration, and/or a physical drawing. During use, the filtering lens 1750 may receive light (e.g., sunlight, light source) from the external environment to illuminate the picture 10. Accordingly, the eyepiece 1740 may be used to view the picture 10 disposed on the filtering lens 1750. As such, the user may view the picture 10 that may be a photograph of a sports player, an athlete, a score sheet from a sports team, a baseball bat, a tennis racket, a football field, and/or any other type of sports related information as desired based on a preference of the user.

While not specifically illustrated in FIG. 10H, the sports article display device 1700 may further include any of the components described above with respect to the sports article display device 100, the sports article display device 200, the sports article display device 300, the sports article display device 400, the sports article display device 500, the sports article display device 600, the sports article display device 700, the sports article display device 800, and/or the sports article display device 900.

Therefore, the sports article display device 1700 may allow viewing of the picture 10 while allowing enjoyment of the main body 1710 that represents sports memorabilia. Also, the sports article display device 1700 may be used for a purpose related to sports.

FIG. 10I illustrates a perspective view of a sports article display device 1800, according to another exemplary embodiment of the present general inventive concept.

The sports article display device 1800 may be constructed from at least one of metal, plastic, wood, glass, and rubber, etc., but is not limited thereto.

The sports article display device 1800 may include a main body 1810, an eyepiece 1840, and a filtering lens 1850, but is not limited thereto.

Referring to FIG. 10I, the main body 1810 is illustrated to be a graduation scroll. However, the main body 1810 may be a graduation cap, a graduation gown, a textbook, a microscope, a telescope, a pencil, a paperweight, a stapler, and/or any other type of school related items known to one of ordinary skill in the art, but is not limited thereto. Also, the main body 1810 may have any size and/or shape based on a preference of the user for a school related object.

The main body 1810 may be rigid. Moreover, the main body 1810 may move (i.e., roll) across an external surface (e.g., a ground surface, a wall).

The eyepiece 1840 may be removably connected (i.e., clip, clamp, clasp, snap, adhesive (e.g., tape, glue), and/or magnet) to at least a portion of the main body 1810. The eyepiece 1840 may include a viewing lens to view contents within the main body 1810 by a user. In other words, the eyepiece 1840 may facilitate viewing within the main body 1810.

The filtering lens 1850 may include a transparent optical lens, but is not limited thereto.

The filtering lens 1850 may be removably connected (i.e., clip, clamp, clasp, snap, adhesive (e.g., tape, glue), and/or magnet) to at least a portion of the main body 1810. More specifically, the filtering lens 1850 may be removably connected within the main body 1810.

Additionally, the filtering lens 1850 may receive a picture 10 thereon, such as a physical photograph, a physical picture, a physical painting, a physical illustration, and/or a physical drawing. During use, the filtering lens 1850 may receive light (e.g., sunlight, light source) from the external environment to illuminate the picture 10. Accordingly, the eyepiece 1840 may be used to view the picture 10 disposed on the filtering lens 1850. As such, the user may view the picture 10 that may be a photograph of a sports player, an athlete, a score sheet from a sports team, a baseball bat, a tennis racket, a football field, and/or any other type of sports related information as desired based on a preference of the user.

While not specifically illustrated in FIG. 10I, the sports article display device 1800 may further include any of the components described above with respect to the sports article display device 100, the sports article display device 200, the sports article display device 300, the sports article display device 400, the sports article display device 500, the sports article display device 600, the sports article display device 700, the sports article display device 800, and/or the sports article display device 900.

Therefore, the sports article display device 1800 may allow viewing of the picture 10 while allowing enjoyment of the main body 1810 that represents sports memorabilia. Also, the sports article display device 1800 may be used for a purpose related to sports without being damaged, such as rolling the main body 1810.

The present general inventive concept may include a sports article display device 100, including a main body 110, an inner tube 120 disposed within at least a portion of the main body 110, an eyepiece 140 removably connected to at least a portion of the inner tube 120 to facilitate viewing, and a filtering lens 150 removably connected to at least a portion of the inner tube 120 to receive a picture 10 thereon to be viewed through the eyepiece 140.

The sports article display device 100 may further include a viewer body 130 removably disposed within at least a portion of the inner tube 120, the viewer body 130 including a first section 131, and a second section 132 removably connected to at least a portion of the first section 131, such that the first section 131 and second section 132 receive the filtering lens 150 therebetween.

The first section 131 and the second section 132 each may include a magnifier receiving groove 131a/132a disposed on at least a portion of the first section 131 and the second section 132, and a lens receiving groove 131b/132b disposed on at least a portion of the first section 131 and the second section 132 to receive the filtering lens 150 therein, such that the lens receiving groove 131b/132b protrudes away from an outer surface of the first section 131 and an outer surface of the second section 132, and is recessed on an interior of the first section 131 and the second section 132.

The sports article display device 100 may further include a magnification lens 160 removably connected to at least a portion of the viewer body 130 to magnify the picture 10 on the filtering lens 150 while viewing the picture 10 through the eyepiece 140.

The filtering lens 150 may receive light from an external environment to illuminate the picture 10.

The present general inventive concept may also include a sports article display device 300, including a main body 310, an inner tube 320 disposed within at least a portion of the main body 310, a display unit 340 disposed at an end of the inner tube 320 to display at least one image 15 thereon, and a control unit 350 disposed within at least a portion of the main body 310 and connected to the display unit 340 to receive the at least one image 15 to be displayed on the display unit 340.

The control unit 350 may receive the at least one image 15 from an external device 20 connected to the control unit 350.

The control unit 350 may adjust at least one setting in response to receiving an input signal from an external device 20.

The control unit 350 may automatically retrieve the at least one image 15 from an external device 20 to be displayed on the display unit 340 in response to the external device 20 being within a predetermined distance of the control unit 350.

The sports article display device 300 may further include an eyepiece 330 removably connected to at least a portion of the inner tube 320 to facilitate viewing of the display unit 340.

The present general inventive concept may also include a sports article display device 400, including a main body 410, an inner tube 420 disposed within at least a portion of the main body 410, an image projecting unit 440 disposed within at least a portion of the main body 410 to display at least one image 15 away therefrom to another medium outside a boundary of the main body 410, and a control unit 450 disposed within at least a portion of the main body 410 and connected to the image projecting unit 440 to receive the at least one image 15 to be to be displayed by the image projecting unit 440.

The image projecting unit 440 may project the at least one image 15 on the another medium.

The image projecting unit 440 may broadcast, via a signal, the at least one image 15 onto an external display screen.

The image projecting unit 440 may project a holographic display of the at least one image 15, such that the holographic display is three-dimensional.

The control unit 450 may extract at least one of image data and video data stored thereon to overlay the at least one image 15.

The present general inventive concept may also include a sports article display device 500, including a main body 510, an inner tube 520 disposed within at least a portion of the main body 510, an eyepiece 540 removably connected to at least a portion of the inner tube 520 to facilitate viewing, a filtering lens 550 removably connected to at least a portion of the inner tube 520 to receive a picture 10 thereon for viewing through the eyepiece 540, and an inflatable bladder 570 disposed within at least a portion of the main body 510 to contact at least a portion of an interior surface of the main body 510 and prevent compression of the main body 510 from an application of force.

The inflatable bladder 570 may increase a rigidity level of the main body 510.

The inflatable bladder 570 may have a ring shape.

The sports article display device 500 may further include an inflation aperture 580 disposed on at least a portion of the main body 510 to receive an air supply unit 30 therein.

The inflation aperture 580 may connect only to the inflatable bladder 570.

The present general inventive concept may also include a sports article display device 600, including a main body 610, an inner tube 620 disposed within at least a portion of the main body 610, an eyepiece 640 removably connected to at least a portion of the inner tube 620 to facilitate viewing, a display unit 650 disposed within at least a portion of the main body 610 to perform at least one of receiving at least one picture 10 thereon for viewing through the eyepiece 640, displaying at least one image 15 thereon, and displaying the at least one image 15 away therefrom to another medium outside a boundary of the main body 610, a control unit 670 disposed within at least a portion of the main body 610 and connected to the display unit to receive the at least image 15 to be displayed on the display unit 650, and an inflatable bladder 655 disposed within at least a portion of the main body 610 to contact at least a portion of an interior surface of the main body 610 and prevent compression of the main body 610 from an application of force.

The eyepiece 640 may be prevented from viewing the at least one image 15 while the at least one picture 10 remains on the display unit 650.

The control unit 670 may prevent the display unit 650 from displaying the at least one image 15 in response to the display unit 650 detecting a presence of the at least one picture 10.

The control unit 670 may extract at least one of image data and video data stored thereon to overlay the at least one image 15.

The sports article display device 600 may further include an inflation aperture 656 disposed on at least a portion of the main body 610 to receive an air supply unit 30 therein.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A sports article display device, comprising:
a main body;
an inner tube disposed within at least a portion of the main body;
an eyepiece removably connected to at least a portion of the inner tube to facilitate viewing; and
a filtering lens removably connected to at least a portion of the inner tube to receive a picture thereon to be viewed through the eyepiece.

2. The sports article display device of claim 1, further comprising:
a viewer body removably disposed within at least a portion of the inner tube, the viewer body comprising:
a first section, and
a second section removably connected to at least a portion of the first section, such that the first section and second section receive the filtering lens therebetween.

3. The sports article display device of claim 2, wherein the first section and the second section each comprise:
a magnifier receiving groove disposed on at least a portion of the first section and the second section; and
a lens receiving groove disposed on at least a portion of the first section and the second section to receive the filtering lens therein, such that the lens receiving groove protrudes away from an outer surface of the first section and an outer surface of the second section, and is recessed on an interior of the first section and the second section.

4. The sports article display device of claim 2, further comprising:
a magnification lens removably connected to at least a portion of the viewer body to magnify the picture on the filtering lens while viewing the picture through the eyepiece.

5. The sports article display device of claim 1, wherein the filtering lens receives light from an external environment to illuminate the picture.

6. A sports article display device, comprising:
a main body;
an inner tube disposed within at least a portion of the main body;
a display unit disposed at an end of the inner tube to display at least one image thereon; and
a control unit disposed within at least a portion of the main body and connected to the display unit to receive the at least one image to be displayed on the display unit.

7. The sports article display device of claim 6, wherein the control unit receives the at least one image from an external device connected to the control unit.

8. The sports article display device of claim 6, wherein the control unit adjusts at least one setting in response to receiving an input signal from an external device.

9. The sports article display device of claim 6, wherein the control unit automatically retrieves the at least one image from an external device to be displayed on the display unit in response to the external device being within a predetermined distance of the control unit.

10. The sports article display device of claim 6, further comprising:
an eyepiece removably connected to at least a portion of the inner tube to facilitate viewing of the display unit.

11. A sports article display device, comprising:
a main body;
an inner tube disposed within at least a portion of the main body;
an image projecting unit disposed within at least a portion of the main body to display at least one image away therefrom to another medium outside a boundary of the main body; and
a control unit disposed within at least a portion of the main body and connected to the image projecting unit to receive the at least one image to be to be displayed by the image projecting unit.

12. The sports article display device of claim 11, wherein the image projecting unit projects the at least one image on the another medium.

13. The sports article display device of claim 11, wherein the image projecting unit broadcasts, via a signal, the at least one image onto an external display screen.

14. The sports article display device of claim 11, wherein the image projecting unit projects a holographic display of the at least one image, such that the holographic display is three-dimensional.

15. The sports article display device of claim 11, wherein the control unit extracts at least one of image data and video data stored thereon to overlay the at least one image.

16. A sports article display device, comprising:
a main body;
an inner tube disposed within at least a portion of the main body;
an eyepiece removably connected to at least a portion of the inner tube to facilitate viewing;
a filtering lens removably connected to at least a portion of the inner tube to receive a picture thereon for viewing through the eyepiece; and
an inflatable bladder disposed within at least a portion of the main body to contact at least a portion of an interior surface of the main body and prevent compression of the main body from an application of force.

17. The sports article display device of claim 16, wherein the inflatable bladder increase a rigidity level of the main body.

18. The sports article display device of claim 16, wherein the inflatable bladder has a ring shape.

19. The sports article display device of claim 16, further comprising:
an inflation aperture disposed on at least a portion of the main body to receive an air supply unit therein.

20. The sports article display device of claim 19, wherein the inflation aperture connects only to the inflatable bladder.

21. A sports article display device, comprising:
a main body;
an inner tube disposed within at least a portion of the main body;
an eyepiece removably connected to at least a portion of the inner tube to facilitate viewing;
a display unit disposed within at least a portion of the main body to perform at least one of receiving at least one picture thereon for viewing through the eyepiece, displaying at least one image thereon, and displaying the at least one image away therefrom to another medium outside a boundary of the main body;
a control unit disposed within at least a portion of the main body and connected to the display unit to receive the at least image to be displayed on the display unit; and
an inflatable bladder disposed within at least a portion of the main body to contact at least a portion of an interior surface of the main body and prevent compression of the main body from an application of force.

22. The sports article display device of claim 21, wherein the eyepiece is prevented from viewing the at least one image while the at least one picture remains on the display unit.

23. The sports article display device of claim 21, wherein the control unit prevents the display unit from displaying the at least one image in response to the display unit detecting a presence of the at least one picture.

24. The sports article display device of claim 21, wherein the control unit extracts at least one of image data and video data stored thereon to overlay the at least one image.

25. The sports article display device of claim 21, further comprising:
an inflation aperture disposed on at least a portion of the main body to receive an air supply unit therein.
